(19) United States
(12) Patent Application Publication
(10) Pub. No.: US 2019/0155438 A1
(43) Pub. Date: May 23, 2019

(54) TOUCH INPUT DEVICE

(71) Applicant: HiDeep Inc., Seongnam-si, Gyeonggi do (KR)

(72) Inventors: Se Yeob KIM, Seongnam-si, Gyeonggi-do (KR); Young Ho CHO, Seongnam-si, Gyeonggi-do (KR); Bon Kee KIM, Seongnam-si, Gyeonggi-do (KR)

(21) Appl. No.: 16/314,035

(22) PCT Filed: May 4, 2017
(86) PCT No.: PCT/KR2017/004728

§ 371 Date: Dec. 28, 2018

(30) Foreign Application Priority Data
Jun. 28, 2016 (KR) 10-2016-0080545

(51) Int. Cl. G06F 3/041; G06F 3/044

(52) U.S. Cl. CPC G06F 3/0412; G06F 3/044; G06F 3/0414

(57) ABSTRACT

A touch input device may be provided that includes: a first cover layer; a spacer layer; a display panel which includes a first substrate layer and a second substrate layer disposed under the first substrate layer; a first electrode and a second electrode which are disposed between the first substrate layer and the second substrate layer; and a third electrode and a fourth electrode which are disposed on the display panel. At least one of the first electrode and the second electrode is used to drive the display panel. A touch position is detected based on a capacitance which changes as an object approaches a touch sensor including at least one of the first electrode, the second electrode, the third electrode, and the fourth electrode and which is detected from the touch sensor. A touch pressure is detected based on a capacitance which is changed by change of a distance between the object and a pressure sensor including at least one of the first electrode, the second electrode, the third electrode, and the fourth electrode and which is detected from the pressure sensor. The spacer layer is disposed between the first cover layer and the pressure sensor.

### TECHNICAL FIELD

The present disclosure relates to a touch input device and more particularly to a touch input device capable of detecting pressure without additional components in the touch input device including a display.

### BACKGROUND ART

Various kinds of input devices are being used to operate a computing system. For example, the input device includes a button, key, joystick and touch screen. Since the touch screen is easy and simple to operate, the touch screen is increasingly being used to operate the computing system.

The touch screen may constitute a touch surface of a touch input device including a touch sensor panel which may be a transparent panel including a touch-sensitive surface. The touch sensor panel is attached to the front side of a display screen, and then the touch-sensitive surface may cover the visible side of the display screen. The touch screen allows a user to operate the computing system by simply touching the touch screen by a finger, etc. Generally, the computing system recognizes the touch and a position of the touch on the touch screen and analyzes the touch, and thus, performs operations in accordance with the analysis.

A demand for a touch input device for detecting not only the touch position but also the magnitude of a touch pressure is increasing. In addition to this, efforts are being made to simplify the configuration and manufacture of such a multifunctional touch input device.

### DISCLOSURE

### Technical Problem

The embodiment of the present invention is designed to meet prior art requirements. An object of the present invention is to provide a touch input device capable of detecting touch pressure.

Another object of the present invention is to provide the touch input device capable of detecting pressure without additional components in the touch input device including a display.

### Technical Solution

One embodiment is a touch input device including: a first cover layer; a spacer layer; a display panel which includes a first substrate layer and a second substrate layer disposed under the first substrate layer; a first electrode and a second electrode which are disposed between the first substrate layer and the second substrate layer; and a third electrode and a fourth electrode which are disposed on the display panel. At least one of the first electrode and the second electrode is used to drive the display panel. A touch position is detected based on a capacitance which changes as an object approaches a touch sensor including at least one of the first electrode, the second electrode, the third electrode, and the fourth electrode and which is detected from the touch sensor. A touch pressure is detected based on a capacitance which is changed by change of a distance between the object and a pressure sensor including at least one of the first electrode, the second electrode, the third electrode, and the fourth electrode and which is detected from the pressure sensor. The spacer layer is disposed between the first cover layer and the pressure sensor.

### Advantageous Effects

According to the embodiment of the present invention, it is possible to provide a touch input device capable of detecting touch pressure.

According to the embodiment of the present invention, it is also possible to provide the touch input device capable of detecting pressure without additional components in the touch input device including a display.

### DESCRIPTION OF DRAWINGS

FIGS. 1a and 1b are schematic views showing a capacitive touch sensor according to an embodiment of the present invention and the configuration for the operation of the touch sensor;

FIG. 2 shows a control block for controlling a touch position, touch pressure, and display operation in a touch input device including a display panel;

FIGS. 3a to 3f are conceptual views showing a relative position of the touch sensor with respect to the display panel in the touch input device according to the embodiment of the present invention;

FIG. 4a shows a first example in which the touch sensor is disposed within a display module;

FIG. 4b shows the arrangement of the touch sensor, which can be applied to the first example shown in FIG. 4a;

FIG. 4c is a conceptual view for describing a first principle of detecting the touch position, which can be applied to the touch sensor arrangement shown in FIG. 4b;

FIG. 4d is a conceptual view for describing a second principle of detecting the touch position, which can be applied to the touch sensor arrangement shown in FIG. 4b;

FIGS. 5a and 5b show a second example and a third example in which the touch sensor is disposed within the display module;

FIG. 6a shows the touch input device according to a first embodiment of the present invention;

FIGS. 6b to 6g show respectively the structure of the touch input device according to the first embodiment of the present invention shown in FIG. 6a;

FIG. 6h shows another touch input device according to the first embodiment of the present invention;

FIGS. 6i to 6k show respectively the structure of the touch input device according to the first embodiment of the present invention shown in FIG. 6h;

FIG. 7a is a display circuit structure diagram of the touch input device according to the first embodiment of the present invention;

FIG. 7b shows an electrical signal which is for detecting the touch position and the touch pressure through the display panel of the touch input device according to the first embodiment of the present invention and is applied to the circuit structure shown in FIG. 7a;

FIG. 8a shows the structure of an OLED display panel which can be applied to the embodiment of the present invention;

FIG. 8b shows the structure of an OLED layer included in the OLED display panel shown in FIG. 8a;

FIGS. 9a and 9b show a touch input device according to a second embodiment of the present invention;

FIG. 9c shows the arrangement of the touch sensor which can be included in the touch input device according to the second embodiment shown in FIGS. 9a and 9b;

FIG. 9d is a conceptual view for describing a principle of detecting the touch position and the touch pressure through the arrangement of the touch sensor shown in FIG. 9c;

FIG. 9e shows the structure of the touch input device according to the second embodiment shown in FIG. 9a;

FIG. 10a is a display circuit structure diagram of the touch input device according to the second embodiment of the present invention;

FIG. 10b shows an electrical signal which is for detecting the touch position and touch pressure through the display panel of the touch input device according to the second embodiment of the present invention and is applied to the circuit structure shown in FIG. 10a;

FIG. 10c shows a control block of a display of the touch input device according to the second embodiment of the present invention;

FIG. 11 shows data profiles in a spatial coordinate when a general touch occurs, when a pressure touch occurs, and when both the general touch and pressure touch occur;

FIG. 12 shows a method of separating a general touch data and a pressure touch data when the general touch and the pressure touch data are mixed; and

FIGS. 13a to 13d show various configurations of the control block included in the touch input device according to the embodiment of the present invention.

### MODE FOR INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereafter, a touch input device according to an embodiment of the present invention will be described. Hereafter, while a capacitive touch sensor 100 is exemplified below, a method for detecting a touch position in another way in accordance with the embodiment of the present invention can be applied.

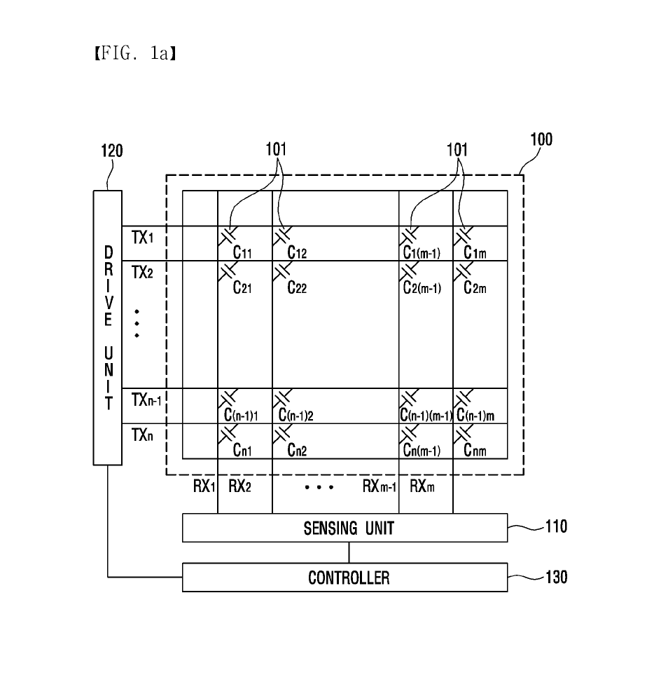

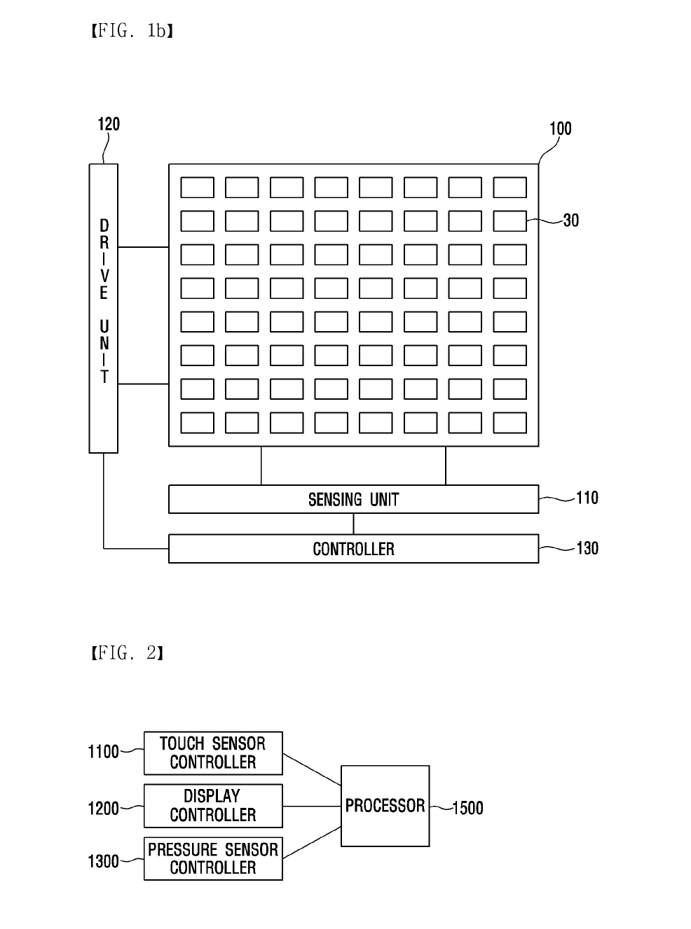

FIG. 1a is a schematic view showing the capacitive touch sensor 100 according to the embodiment of the present invention and the configuration for the operation of the touch sensor. Referring to FIG. 1a, the touch sensor 100 according to the embodiment of the present invention may include a plurality of drive electrodes TX1 to TXn and a plurality of receiving electrodes RX1 to RXm, and may include a drive unit 120 which applies a drive signal to the plurality of the drive electrodes TX1 to TXn for the purpose of the operation of the touch sensor 100, and a sensing unit 110 which detects whether the touch occurs or not and/or the touch position by receiving a sensing signal including information on a capacitance change amount changing according to the touch on a touch surface of the touch sensor 100.

As shown in Fig. la, the touch sensor 100 may include the plurality of drive electrodes TX1 to TXn and the plurality of receiving electrodes RX1 to RXm. While Fig. la shows that the plurality of drive electrodes TX1 to TXn and the plurality of receiving electrodes RX1 to RXm of the touch sensor 100 form an orthogonal array, the present invention is not limited to this. The plurality of drive electrodes TX1 to TXn and the plurality of receiving electrodes RX1 to RXm has an array of arbitrary dimension, for example, a diagonal array, a concentric array, a 3-dimensional random array, etc., and an array obtained by the application of them. Here, “n” and “m” are positive integers and may be the same as each other or may have different values. The magnitude of the value may be changed depending on the embodiment.

As shown in FIG. 1a, the plurality of drive electrodes TX1 to TXn and the plurality of receiving electrodes RX1 to RXm may be arranged to cross each other. The drive electrode TX may include the plurality of drive electrodes TX1 to TXn extending in a first axial direction. The receiving electrode RX may include the plurality of receiving electrodes RX1 to RXm extending in a second axial direction crossing the first axial direction.

In the touch sensor 100 according to the embodiment of the present invention, the plurality of drive electrodes TX1 to TXn and the plurality of receiving electrodes RX1 to RXm may be formed in the same layer. For example, the plurality of drive electrodes TX1 to TXn and the plurality of receiving electrodes RX1 to RXm may be formed on the same side of an insulation layer (not shown). Also, the plurality of drive electrodes TX1 to TXn and the plurality of receiving electrodes RX1 to RXm may be formed in the different layers. For example, the plurality of drive electrodes TX1 to TXn and the plurality of receiving electrodes RX1 to RXm may be formed on both sides of one insulation layer (not shown) respectively, or the plurality of drive electrodes TX1 to TXn may be formed on a side of a first insulation layer (not shown) and the plurality of receiving electrodes RX1 to RXm may be formed on a side of a second insulation layer (not shown) different from the first insulation layer.

The plurality of drive electrodes TX1 to TXn and the plurality of receiving electrodes

RX1 to RXm may be made of a transparent conductive material (for example, indium tin oxide (ITO) or antimony tin oxide (ATO) which is made of tin oxide (SnO₂), and indium oxide (In₂O₃), etc.), or the like. However, this is only an example. The drive electrode TX and the receiving electrode RX may be also made of another transparent conductive material or an opaque conductive material. For instance, the drive electrode TX and the receiving electrode RX may be formed to include at least any one of silver ink, copper, nano silver, or carbon nanotube (CNT). Also, the drive electrode TX and the receiving electrode RX may be made of metal mesh.

The drive unit 120 according to the embodiment may apply a drive signal to the drive electrodes TX1 to TXn. In the embodiment, one drive signal may be sequentially applied at a time to the first drive electrode TX1 to the n-th drive electrode TXn. The drive signal may be applied again repeatedly. This is only an example. The drive signal may be applied to the plurality of drive electrodes at the same time in accordance with the embodiment.

Through the receiving electrodes RX1 to RXm, the sensing unit 110 receives the sensing signal including information on a capacitance (Cm) 101 generated between the receiving electrodes RX1 to RXm and the drive electrodes TX1 to TXn to which the drive signal has been applied, thereby detecting whether or not the touch has occurred and where the touch has occurred. For example, the sensing signal may be a signal coupled by the capacitance (Cm) 101 generated between the receiving electrode RX and the drive electrode

TX to which the drive signal has been applied. As such, the process of sensing the drive signal applied from the first drive electrode TX1 to the n-th drive electrode TXn through the receiving electrodes RX1 to RXm can be referred to as a process of scanning the touch sensor 100.

For example, the sensing unit 110 may include a receiver (not shown) which is connected to each of the receiving electrodes RX1 to RXm through a switch. The switch becomes the on-state in a time interval in which the signal of the corresponding receiving electrode RX is detected, thereby allowing the receiver to detect the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground or a reference voltage. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (Cm) 101, and then converts the integrated current signal into voltage. The sensing unit 110 may further include an analog-digital converter (ADC) (not shown) which converts the integrated data by the receiver into digital data. Later, the digital data may be input to a processor (not shown) and processed to obtain information on the touch on the touch sensor 100. The sensing unit 110 may include the ADC and processor as well as the receiver.

A controller 130 may perform a function of controlling the operations of the drive unit 120 and the sensing unit 110. For example, the controller 130 generates and transmits a drive control signal to the drive unit 120, so that the drive signal can be applied to a predetermined drive electrode TX1 for a predetermined time period. Also, the controller 130 generates and transmits a sensing control signal to the sensing unit 110, so that the sensing unit 110 may receive the sensing signal from the predetermined receiving electrode RX for a predetermined time period and perform a predetermined function.

As described above, a capacitance (C) with a predetermined value is formed at each crossing of the drive electrode TX and the receiving electrode RX. When an object such as a finger approaches close to the touch sensor 100, the value of the capacitance may be changed. In FIG. 1, the capacitance may represent a mutual capacitance (Cm). The sensing unit 110 detects such electrical characteristics, thereby detecting whether the touch has occurred on the touch sensor 100 or not and where the touch has occurred. For example, the sensing unit 110 is able to detect whether the touch has occurred on the surface of the touch sensor 100 comprised of a two-dimensional plane consisting of a first axis and a second axis.

More specifically, when the touch occurs on the touch sensor 100, the drive electrode TX to which the drive signal has been applied is detected, so that the position of the second axial direction of the touch can be detected. Likewise, when the touch occurs on the touch sensor 100, the capacitance change is detected from the reception signal received through the receiving electrode RX, so that the position of the first axial direction of the touch can be detected.

The foregoing has described in detail the mutual capacitance type touch sensor 100 as the touch sensor 100. However, in a touch input device 1000 according to the embodiment of the present invention, the touch sensor 100 for detecting whether or not the touch has occurred and the touch position may be implemented by using not only the above-described method but also any touch sensing method such as a self-capacitance type method, a surface capacitance type method, a projected capacitance type method, a resistance film method, a surface acoustic wave (SAW) method, an infrared method, an optical imaging method, a dispersive signal technology, and an acoustic pulse recognition method, etc.

Hereinafter, a component corresponding to the drive electrode TX and the receiving electrode RX for detecting whether or not the touch has occurred and/or the touch position can be referred to as a touch sensor.

In FIG. 1a, the drive unit 120 and the sensing unit 110 may constitute a touch sensor controller 1100 capable of detecting whether the touch has occurred on the touch sensor 100 according to the embodiment of the present invention or not and/or where the touch has occurred. The touch sensor controller 1100 according to the embodiment of the present invention may further include the controller 130. The touch sensor controller 1100 according to the embodiment of the present invention may be integrated and implemented on a touch sensing integrated circuit (IC, not shown) in a touch input device 1000 including the touch sensor 100. The drive electrode TX and the receiving electrode RX included in the touch sensor 100 may be connected to the drive unit 120 and the sensing unit 110 included in the touch sensing IC through, for example, a conductive trace and/or a conductive pattern printed on a circuit board, or the like. The touch sensing IC may be located on a circuit board on which the conductive pattern has been printed. According to the embodiment, the touch sensing IC may be mounted on a main board for operation of the touch input device 1000.

Up to now, although the operation mode of the touch sensor 100 sensing the touch position has been described on the basis of the mutual capacitance change amount between the drive electrode TX and the receiving electrode RX, the embodiment of the present invention is not limited to this. That is, as shown in FIG. 1b, it is also possible to detect the touch position on the basis of the change amount of a self-capacitance.

FIG. 1b is schematic views of a configuration of another capacitance type touch sensor 100 included in a touch input device according to another embodiment of the present invention and the operation of the capacitance type touch sensor. A plurality of single electrodes 30 are provided on the touch sensor 100 shown in FIG. 1b. Although the plurality of single electrodes 30 may be, as shown in FIG. 1b, disposed at a regular interval in the form of a grid, the present invention is not limited to this.

The drive control signal generated by the controller 130 is transmitted to the drive unit 120. On the basis of the drive control signal, the drive unit 120 applies the drive signal to the predetermined touch electrode 30 for a predetermined time period. Also, the sensing control signal generated by the controller 130 is transmitted to the sensing unit 110. On the basis of the sensing control signal, the sensing unit 110 receives the sensing signal from the predetermined single electrode 30 for a predetermined time period. Here, the sensing signal may be a signal for the change amount of the self-capacitance formed on the single electrode 30.

Here, whether the touch has occurred on the touch sensor 100 or not and/or the touch position are detected by the sensing signal detected by the sensing unit 110. For example, since the coordinate of the single electrode 30 has been known in advance, whether the touch of the object on the surface of the touch sensor 100 has occurred or not and/or the touch position can be detected.

In the foregoing, for convenience of description, it has been described that the drive unit 120 and the sensing unit 110 operate individually as a separate block. However, the operation to apply the drive signal to the single electrode 30 and to receive the sensing signal from the single electrode 30 can be also performed by one drive and sensing unit.

FIG. 2 shows a control block for controlling a touch position, touch pressure, and display operation in a touch input device including a display panel. In the touch input device 1000 configured to detect the touch pressure in addition to the display function and touch position detection, the control block may include the above-described touch sensor controller 1100 for detecting the touch position, a display controller 1200 for driving the display panel, and a pressure sensor controller 1300 for detecting the pressure. The display controller 1200 may include a control circuit which receives an input from an application processor (AP) or a central processing unit (CPU) on a main board for the operation of the touch input device 1000 and displays the contents that a user wants on the display panel 200A. The control circuit may include a display panel control IC, a graphic controller IC, and a circuit required to operate other display panel 200A.

The pressure sensor controller 1300 for detecting the pressure through a pressure sensor may be configured similarly to the touch sensor controller 1100, and thus, may operate similarly to the touch sensor controller 1100.

According to the embodiment, the touch sensor controller 1100, the display controller 1200, and the pressure sensor controller 1300 may be included as different components in the touch input device 1000. For example, the touch sensor controller 1100, the display controller 1200, and the pressure sensor controller 1300 may be composed of different chips respectively. Here, a processor 1500 of the touch input device 1000 may function as a host processor for the touch sensor controller 1100, the display controller 1200, and the pressure sensor controller 1300.

The touch input device 1000 according to the embodiment of the present invention may include an electronic device including a display screen and/or a touch screen, such as a cell phone, a personal data assistant (PDA), a smartphone, a tablet personal computer (PC).

In order to manufacture such a thin and lightweight light-weighing touch input device 1000, the touch sensor controller 1100, the display controller 1200, and the pressure sensor controller 1300, which are, as described above, formed separately from each other, may be integrated into one or more configurations in accordance with the embodiment of the present invention. In addition to this, these controllers can be integrated into the processor 1500 respectively. Also, according to the embodiment of the present invention, the touch sensor 100 and/or the pressure sensor may be integrated into the display panel 200A.

Hereinafter, the touch input device 1000 configured to be able to sense the pressure by using an inner electrode included in the touch sensor 100 and/or in the display panel 200A without adding configurations for detecting the pressure to the touch input device 1000 will be described.

In the touch input device 1000 according to the embodiment of the present invention, the touch sensor 100 for detecting the touch position may be positioned outside or inside the display panel 200A. The display panel 200A of the touch input device 1000 according to the embodiment of the present invention may be a display panel included in a liquid crystal display (LCD), a plasma display panel (PDP), an organic light emitting diode (OLED), etc. Accordingly, a user may perform the input operation by touching the touch surface while visually identifying an image displayed on the display panel.

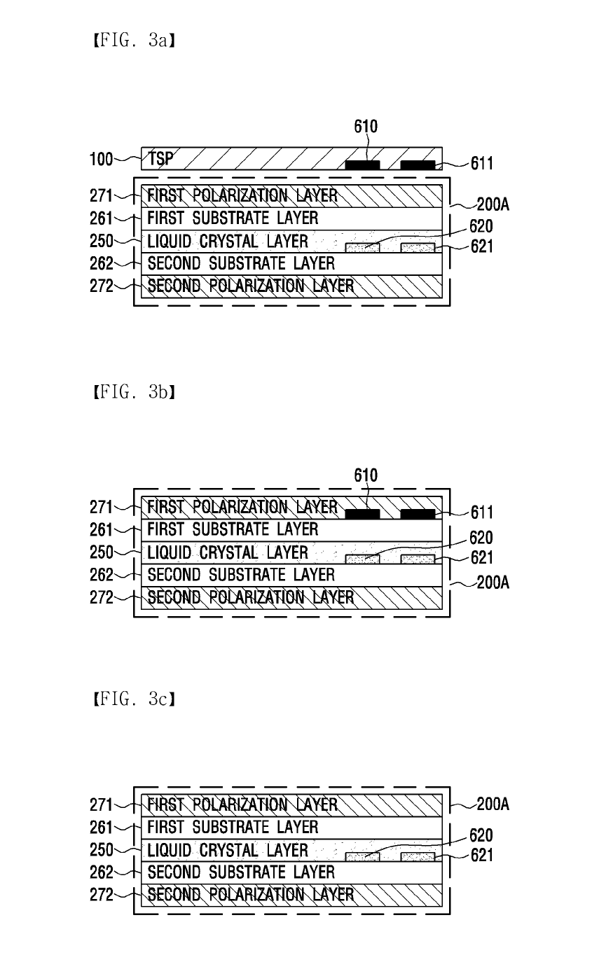

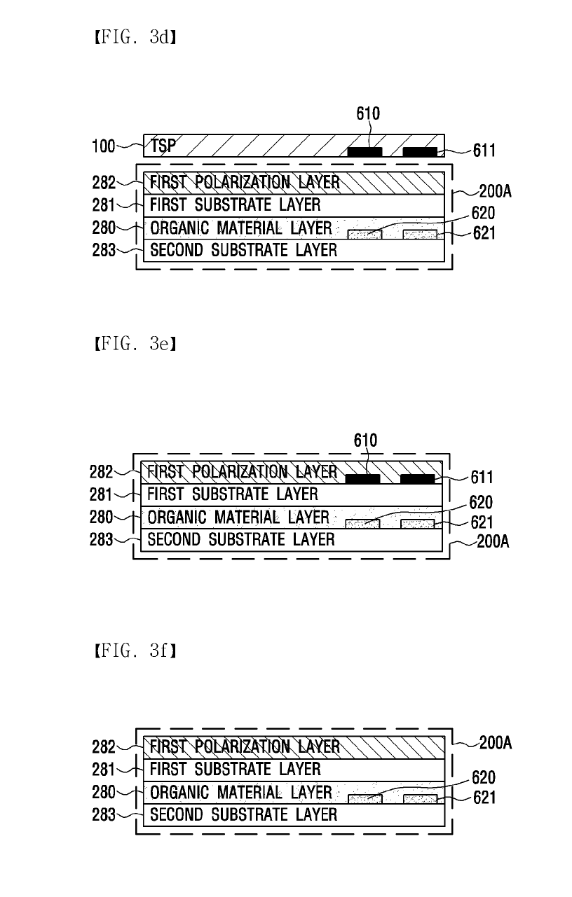

FIGS. 3a to 3f are conceptual views showing a relative position of the touch sensor 100 with respect to the display panel 200A in the touch input device 1000 according to the embodiment of the present invention. First, the configuration of the display panel 200A using an LCD panel will be described with reference to FIGS. 3a to 3c.

As shown in FIGS. 3a to 3c, the LCD panel may include a liquid crystal layer 250 including a liquid crystal cell, a first substrate layer 261 and a second substrate layer 262 which are disposed on both sides of the liquid crystal layer 250 and include electrodes, a first polarization layer 271 formed on a side of the first substrate layer 261 in a direction facing the liquid crystal layer 250, and a second polarization layer 272 formed on a side of the second substrate layer 262 in the direction facing the liquid crystal layer 250. Here, the first substrate layer 261 may be made of color filter glass, and the second substrate layer 262 may be made of TFT glass. Also, according to the embodiment, at least one of the first substrate layer 261 and the second substrate layer 262 may be made of a bendable material such as plastic. In FIGS. 3a to 3c, the second substrate layer 262 may be comprised of various layers including a data line, a gate line, TFT, a common electrode Vcom, and a pixel electrode, etc. These electrical components may operate in such a manner as to generate a controlled electric field and orient liquid crystals located in the liquid crystal layer 250.

Next, the configuration of the display panel 200A using an OLED panel will be described with reference to FIGS. 3d to 3f.

As shown in FIGS. 3d to 3f, the OLED panel may include an organic material layer 280 including an organic light-emitting diode (OLED), a first substrate layer 281 and a second substrate layer 283 which are disposed on both sides of the organic material layer 280 and include electrodes, and a first polarization layer 282 formed on a side of the first substrate layer 281 in a direction facing the liquid crystal layer 250. Here, the first substrate layer 281 may be made of encapsulation glass, and the second substrate layer 283 may be made of TFT glass. Also, according to the embodiment, at least one of the first substrate layer 281 and the second substrate layer 283 may be made of a bendable material such as plastic. The OLED panel shown in FIGS. 3d and 3f may include an electrode used to drive the display panel 200A, such as a gate line, a data line, a first power line (ELVDD), a second power line (ELVSS), etc. The organic light-emitting diode (OLED) panel is a self-light emitting display panel which uses a principle where, when current flows through a fluorescent or phosphorescent organic thin film and then electrons and electron holes are combined in the organic material layer, so that light is generated. The organic material constituting the light emitting layer determines the color of the light.

Specifically, the OLED uses a principle in which when electricity flows and an organic matter is applied on glass or plastic, the organic matter emits light. That is, the principle is that electron holes and electrons are injected into the anode and cathode of the organic matter respectively and are recombined in the light emitting layer, so that a high energy exciton is generated and the exciton releases the energy while falling down to a low energy state and then light with a particular wavelength is generated. Here, the color of the light is changed according to the organic matter of the light emitting layer.

The OLED includes a line-driven passive-matrix organic light-emitting diode (PM-OLED) and an individual driven active-matrix organic light-emitting diode (AM-OLED) in accordance with the operating characteristics of a pixel constituting a pixel matrix. None of them require a backlight. Therefore, the OLED enables a very thin display module to be implemented, has a constant contrast ratio according to an angle and obtains good color reproductivity depending on a temperature. Also, it is very economical in that non-driven pixel does not consume power.

In terms of operation, the PM-OLED emits light only during a scanning time at a high current, and the AM-OLED maintains a light emitting state only during a frame time at a low current. Therefore, the AM-OLED has a resolution higher than that of the PM-OLED and is advantageous for driving a large area display panel and consumes low power. Also, a thin film transistor (TFT) is embedded in the AM-OLED, and thus, each component can be individually controlled, so that it is easy to implement a delicate screen.

It will be apparent to a skilled person in the art that the LCD panel or the OLED panel may further include other structures so as to perform the display function and may be deformed.

FIGS. 3a and 3d show that, in the touch input device 1000, the touch sensor 100 is disposed outside the display panel 200A. The touch sensor panel may be disposed on the display panel 200A, and third electrode 610 and a fourth electrode 611 may be included in the touch sensor panel. The touch surface of the touch input device 1000 may be the surface of the touch sensor panel. Also, a first electrode 620 and a second electrode 621 may be disposed on the second substrate layers 262 and 283.

FIGS. 3b, 3c, 3e, and 3f show that, in the touch input device 1000, the touch sensor 100 is disposed inside the display panel 200A.

FIGS. 3b and 3e show that the third electrode 610 and the fourth electrode 611 are disposed between the first substrate layers 261 and 281 and the first polarization layers 271 and 282. Here, the touch surface of the touch input device 1000 is the outer surface of the display panel 200A and may be the top surface or the bottom surface of FIGS. 3b and 3e. Also, the first electrode 620 and the second electrode 621 may be disposed on the second substrate layers 262 and 283.

In FIGS. 3c and 3f, the first electrode 620 and the second electrode 621 may be disposed on the second substrate layers 262 and 283.

The touch surface of the touch input device 1000 shown in FIGS. 3a to 3f is the outer surface of the display panel 200A and may be the top surface or the bottom surface of the display panel 200A. Here, in FIGS. 3a to 3f, the top surface or the bottom surface of the display panel 200A, which can be the touch surface, may be covered with a cover layer (not shown) in order to protect the display panel 200A.

Further, at least one of the first electrode 620 and the second electrode 621 may be an electrode used to drive the display panel 200A. Specifically, when the display panel 200A is the LCD panel, at least one of the first electrode 620 and the second electrode 621 may include at least one of a data line, a gate line, TFT, a common electrode Vcom, and a pixel electrode, etc. When the display panel 200A is the OLED panel, at least one of the first electrode 620 and the second electrode 621 may include a data line, a gate line, a first power line (ELVDD), and a second power line (ELVSS). Further, although FIGS. 3a to 3f show that the first electrode 620 and the second electrode 621 are disposed on the second substrate layers 262 and 283, there is no limitation to this. The first electrode 620 and the second electrode 621 may be disposed under the first substrate layers 261 and 281, or alternatively one of the first electrode 620 and the second electrode 621 may be disposed on the second substrate layers 262 and 283, and the other may be disposed under the first substrate layers 261 and 281.

Also, according to the embodiment of the present invention, at least a portion of the touch sensor 100 may be configured to be placed within the display panel 200A and at least a portion of the remaining touch sensor 100 may be configured to be placed outside the display panel 200A. For example, one of the drive electrode TX and the receiving electrode RX, which constitute the touch sensor panel, may be configured to be placed outside the display panel 200A, and the other may be configured to be placed inside the display panel 200A. When the touch sensor 100 is placed within the display panel 200A, an electrode for operation of the touch sensor may be additionally disposed. However, various configurations and/or electrodes positioned inside the display panel 200A may be used as the touch sensor 100 for sensing the touch. Also, according to the embodiment of the present invention, at least a portion of the touch sensor 100 may be configured to be placed between the first substrate layers 261 and 281 and the second substrate layers 262 and 283 which are included in the display panel 200A. Here, the remaining portion other than the at least a portion of the touch sensor may be disposed both within the display panel 200A and at a position other than between the first substrate layers 261 and 281 and the second substrate layers 262 and 283.

Next, a method for detecting the touch position by using a portion of the first electrode 620, the second electrode 621, the third electrode 610, and the fourth electrode 611 shown in FIGS. 3a to 3f will be described. The touch position can be detected based on the capacitance which changes as the object approaches the touch sensor including at least one of the first electrode 620, the second electrode 621, the third electrode 610, and the fourth electrode 611 and which is detected from the touch sensor.

The touch sensor 100 of the touch input device 1000 shown in FIGS. 3a, 3b, 3d, and 3e may be composed of the third electrode 610 and the fourth electrode 611. Specifically, the third electrode 610 and the fourth electrode 611 may function as the drive electrode and the receiving electrode described in FIG. 1a and may detect the touch position in accordance with the mutual capacitance between the third electrode 610 and the fourth electrode 611. Also, the third electrode 610 and the fourth electrode 611 may function as a single electrode 30 described in FIG. 1b and the touch position may be detected based on the self-capacitance of each of the third electrode 610 and the fourth electrode 611.

Further, the touch sensor 100 of the touch input device 1000 shown in FIGS. 3b and 3e may be composed of the third electrode 610 and the first electrode 620. Specifically, the third electrode 610 and the first electrode 620 may function as the drive electrode and the receiving electrode described in Fig. la and the touch position may be detected based on the mutual capacitance between the third electrode 610 and the first electrode 620. Here, when the first electrode 620 is used to drive the display panel 200A, the display panel 200A may be driven in a first time interval and the touch position may be detected in a second time interval different from the first time interval.

The touch sensor 100 of the touch input device 1000 shown in FIGS. 3c and 3f may be composed of the first electrode 620 and the second electrode 621. Specifically, the first electrode 620 and the second electrode 621 may function as the drive electrode and the receiving electrode described in FIG. 1a and the touch position may be detected based on the mutual capacitance between the first electrode 620 and the second electrode 621. Also, the first electrode 620 and the second electrode 621 may function as the single electrode 30 described in FIG. 1b and the touch position may be detected based on the self-capacitance of each of the first electrode 620 and the second electrode 621. Here, when the first electrode 620 and/or the second electrode 621 are used to drive the display panel 200A, the display panel 200A may be driven in the first time interval and the touch position may be detected in the second time interval different from the first time interval.

Next, a method for detecting the touch pressure by using a portion of the first electrode 620, the second electrode 621, the third electrode 610, and the fourth electrode 611 shown in FIGS. 3a to 3f will be described. The touch pressure can be detected based on the capacitance which is changed by change of a distance between a reference potential and the pressure sensor including at least one of the first electrode 620, the second electrode 621, the third electrode 610, and the fourth electrode 611 and which is detected from the pressure sensor.

The pressure sensor of the touch input device 1000 shown in FIGS. 3a, 3b, 3d, and 3e may be composed of the third electrode 610 and the fourth electrode 611. Specifically, in a case where the reference potential is an object, when pressure is applied to the cover layer (not shown) by the object, a distance between the pressure sensor and the object changes. As the distance between the pressure sensor and the object changes, the mutual capacitance between the third electrode 610 and the fourth electrode 611 may change. Also, in a case where the reference potential is spaced from the pressure sensor and the reference potential is a reference potential layer (not shown) which is placed on, under or within the display panel 200A, when pressure is applied to the touch surface, a distance between the reference potential layer and the pressure sensor changes. Due to the distance change between the pressure sensor and the reference potential layer, the mutual capacitance between the third electrode 610 and the fourth electrode 611 may change. As such, the touch pressure can be detected according to the mutual capacitance between the third electrode 610 and the fourth electrode 611. Here, when the touch sensor 100 is composed of the third electrode 610 and the fourth electrode 611, it is possible to detect the touch position and simultaneously to detect the touch pressure. Further, the touch position may be detected in the first time interval, and the touch pressure may be detected in the second time interval different from the first time interval. Also, when the first electrode 620 and/or the second electrode 621 used to drive the display panel 200A are disposed between the reference potential layer and the third electrode 610 and the fourth electrode 611, which are pressure sensors, the first electrode 620 and/or the second electrode 621 may be floating during the time interval in which the touch pressure is detected, in order to detect the capacitance change according to the distance change between the pressure sensor and the reference potential layer.

Also, the pressure sensor of the touch input device 1000 shown in FIGS. 3a, 3b, 3d, and 3e may be composed of at least one of the third electrode 610 and the fourth electrode 611. Specifically, in a case where the reference potential is an object, when pressure is applied to the cover layer (not shown) by the object, a distance between the pressure sensor and the object changes. As the distance between the pressure sensor and the object changes, the capacitance between the third electrode 610 and the object, that is, the self-capacitance of the third electrode 610 and/or the capacitance between the fourth electrode 611 and the object, that is, the self-capacitance of the fourth electrode 611 may change. Also, in a case where the reference potential is spaced from the pressure sensor and the reference potential is the reference potential layer (not shown) which is placed on, under or within the display panel 200A, when pressure is applied to the touch surface, a distance between the reference potential layer and the pressure sensor changes. Due to the distance change between the pressure sensor and the reference potential layer, the capacitance between the third electrode 610 and the reference potential layer, that is, the self-capacitance of the third electrode 610 and/or the capacitance between the fourth electrode 611 and the reference potential layer, that is, the self-capacitance of the fourth electrode 611 may change. As such, the touch pressure can be detected according to the self-capacitance of the third electrode 610 and/or the fourth electrode 611. Here, when the touch sensor 100 is composed of the third electrode 610 and the fourth electrode 611, it is possible to detect the touch position and simultaneously to detect the touch pressure. Also, the touch position may be detected in the first time interval, and the touch pressure may be detected in the second time interval different from the first time interval. Further, when the first electrode 620 and/or the second electrode 621 used to drive the display panel 200A are disposed between the reference potential layer and the third electrode 610 and/or the fourth electrode 611, which are pressure sensors, the first electrode 620 and/or the second electrode 621 may be floating during the time interval in which the touch pressure is detected, in order to detect the capacitance change according to the distance change between the pressure sensor and the reference potential layer.

Further, the touch sensor 10 of the touch input device 1000 shown in FIGS. 3b and 3e may be composed of the third electrode 610 and the first electrode 620. Specifically, in a case where the reference potential is an object, when pressure is applied to the cover layer (not shown) by the object, a distance between the pressure sensor and the object changes. As the distance between the pressure sensor and the object changes, the mutual capacitance between the third electrode 610 and the first electrode 620 may change. Also, in a case where the reference potential is spaced from the pressure sensor and the reference potential is a reference potential layer (not shown) which is placed on, under or within the display panel 200A, when pressure is applied to the touch surface, a distance between the reference potential layer and the pressure sensor changes. Due to the distance change between the pressure sensor and the reference potential layer, the mutual capacitance between the third electrode 610 and the first electrode 620 may change. As such, the touch pressure can be detected according to the mutual capacitance between the third electrode 610 and the first electrode 620. Here, when the touch sensor 100 includes at least one of the third electrode 610 and the first electrode 620, it is possible to detect the touch position and simultaneously to detect the touch pressure. Also, the touch position may be detected in the first time interval, and the touch pressure may be detected in the second time interval different from the first time interval. Here, when the electrode used to drive the display panel 200A includes at least one of the first electrode 620 and the second electrode 621, not only the display panel 200A can be driven but also the touch pressure can be detected. Also, the display panel 200A may be driven in the first time interval and the touch pressure may be detected in the second time interval different from the first time interval. Here, when the touch sensor 100 includes at least one of the third electrode 610 and the fourth electrode 611 and the electrode used to drive the display panel 200A includes at least one of the first electrode 620 and the second electrode 621, not only the display panel 200A can be driven but also the touch position and the touch pressure can be detected. Further, the touch position may be detected in the first time interval, the touch pressure may be detected in the second time interval different from the first time interval, and the display panel 200A may be driven in a third time interval different from the first time interval and the second time interval. Also, when the second electrode 621 used to drive the display panel 200A is disposed between the reference potential layer and the third electrode 610 which is the pressure sensor, the second electrode 621 may be floating during the time interval in which the touch pressure is detected, in order to detect the capacitance change according to the distance change between the pressure sensor and the reference potential layer.

The pressure sensor of the touch input device 1000 shown in FIGS. 3a to 3f may be composed of the first electrode 620 and the second electrode 621. Specifically, in a case where the reference potential is an object, when pressure is applied to the cover layer (not shown) by the object, a distance between the pressure sensor and the object changes. As the distance between the pressure sensor and the object changes, the mutual capacitance between the first electrode 620 and the second electrode 621 may change. Also, in a case where the reference potential is spaced from the pressure sensor and the reference potential is a reference potential layer (not shown) which is placed on, under or within the display panel 200A, when pressure is applied to the touch surface, a distance between the reference potential layer and the pressure sensor changes. Due to the distance change between the pressure sensor and the reference potential layer, the mutual capacitance between the first electrode 620 and the second electrode 621 may change. As such, the touch pressure can be detected according to the mutual capacitance between the first electrode 620 and the second electrode 621. Here, when the electrode used to drive the display panel 200A includes at least one of the first electrode 620 and the second electrode 621, the touch pressure can be detected simultaneously with driving the display panel 200A. Also, the display panel 200A may be driven in the first time interval and the touch pressure may be detected in the second time interval different from the first time interval. Here, when the touch sensor 100 includes at least one of the first electrode 620 and the second electrode 621, it is possible to detect the touch position and simultaneously to detect the touch pressure. Also, the touch position may be detected in the first time interval, and the touch pressure may be detected in the second time interval different from the first time interval. Here, when the touch sensor 100 includes at least one of the first electrode 620 and the second electrode 621 and the electrode used to drive the display panel 200A includes at least one of the first electrode 620 and the second electrode 621, the touch position and the touch pressure can be detected simultaneously with driving the display panel 200A. Further, the touch position may be detected in the first time interval, the touch pressure may be detected in the second time interval different from the first time interval, and the display panel 200A may be driven in the third time interval different from the first time interval and the second time interval.

Also, the pressure sensor of the touch input device 1000 shown in FIGS. 3a to 3f may be composed of at least one of the first electrode 620 and the second electrode 621. Specifically, in a case where the reference potential is an object, when pressure is applied to the cover layer (not shown) by the object, a distance between the pressure sensor and the object changes. As the distance between the pressure sensor and the object changes, the capacitance between the first electrode 620 and the object, that is, the self-capacitance of the first electrode 620 and/or the capacitance between the second electrode 621 and the object, that is, the self-capacitance of the second electrode 621 may change. Also, in a case where the reference potential is spaced from the pressure sensor and the reference potential is the reference potential layer (not shown) which is placed on, under or within the display panel 200A, when pressure is applied to the touch surface, a distance between the reference potential layer and the pressure sensor changes. Due to the distance change between the pressure sensor and the reference potential layer, the capacitance between the first electrode 620 and the reference potential layer, that is, the self-capacitance of the first electrode 620 and/or the capacitance between the second electrode 621 and the reference potential layer, that is, the self-capacitance of the second electrode 621 may change. As such, the touch pressure can be detected according to the self-capacitance of the first electrode 620 and/or the second electrode 621. Here, when the electrode used to drive the display panel 200A includes at least one of the first electrode 620 and the second electrode 621, the touch pressure can be detected simultaneously with driving the display panel 200A. Also, the display panel 200A may be driven in the first time interval and the touch pressure may be detected in the second time interval different from the first time interval. Here, when the touch sensor 100 includes at least one of the first electrode 620 and the second electrode 621, it is possible to detect the touch position and simultaneously to detect the touch pressure. Also, the touch position may be detected in the first time interval, and the touch pressure may be detected in the second time interval different from the first time interval. Here, when the touch sensor 100 includes at least one of the first electrode 620 and the second electrode 621 and the electrode used to drive the display panel 200A includes at least one of the first electrode 620 and the second electrode 621, the touch position and the touch pressure can be detected simultaneously with driving the display panel 200A. Further, the touch position may be detected in the first time interval, the touch pressure may be detected in the second time interval different from the first time interval, and the display panel 200A may be driven in the third time interval different from the first time interval and the second time interval.

Here, when the reference potential is an object, the distance between the object and the pressure sensor should change when the pressure is applied to the touch input device 1000 by the object. Therefore, a spacer layer may be disposed between the object and the pressure sensor. Specifically, the spacer layer may be disposed between the cover layer and the pressure sensor. Here, the cover layer may be made of a transparent material-made glass or plastic, etc., such that an image output from a display module 200 disposed under the cover layer is visible to the outside. Further, the cover layer may be made of a flexible material which can be bent at least at a position where the pressure is applied, such that the spacer layer is compressed when the pressure is applied to the cover layer.

Further, when the reference potential is spaced from the pressure sensor and the reference potential is a reference potential layer (not shown) which is placed on, under or within the display panel 200A, the reference potential layer may be disposed on the display panel 200A. Specifically, the reference potential layer may be disposed between the display panel 200A and the cover layer which is disposed on the display panel 200A and functions to protect the display panel 200A. More specifically, the reference potential layer may be formed on the bottom surface of the cover layer. Further, the distance between the reference potential layer and the pressure sensor should be changeable at the time of applying the pressure to the touch input device 1000. Therefore, a spacer layer may be disposed between the reference potential layer and the pressure sensor. When the pressure sensor does not include the first electrode 620 or the second electrode 621 in the touch input device 1000 shown in FIGS. 3a and 3d, the reference potential layer may be disposed between the pressure sensor and the display panel 200A or disposed on the pressure sensor.

According to the embodiment, the spacer layer may be implemented by an air gap. According to the embodiment, the spacer layer may be made of an impact absorbing material. According to the embodiment, the spacer layer may be filled with a dielectric material. According to the embodiment, the spacer layer may be made of a material having a restoring force by which the material contracts by applying the pressure and returns to its original shape by releasing the pressure. According to the embodiment, the spacer layer may be made of an elastic foam. Also, since the spacer layer is disposed on or inside the display panel 200A, the spacer layer may be made of a transparent material.

According to the embodiment, when the spacer layer is disposed within the display panel 200A, the spacer layer may be the air gap which is included during the manufacture of the display panel 200A and/or a backlight unit. When the display panel 200A and/or the backlight unit include one air gap, the one air gap may function as the spacer layer. When the display panel 200A and/or the backlight unit include a plurality of the air gaps, the plurality of air gaps may collectively function as the spacer layer.

When the touch sensor 100 and/or the pressure sensor include the first electrode 620 or the second electrode 621 and the display panel 200A is the LCD panel, at least one of a data line, a gate line, a common electrode, and a pixel electrode may be used as the touch sensor 100 and/or the pressure sensor. Also, when the display panel 200A is the OLED panel, at least one of a gate line, a data line, a first power line (ELVDD), and a second power line (ELVSS) may be used as the touch sensor 100 and/or the pressure sensor. In addition, according to the embodiment, at least one of the electrodes included in the display other than the electrodes described herein may be used as the touch sensor 100 and/or the pressure sensor.

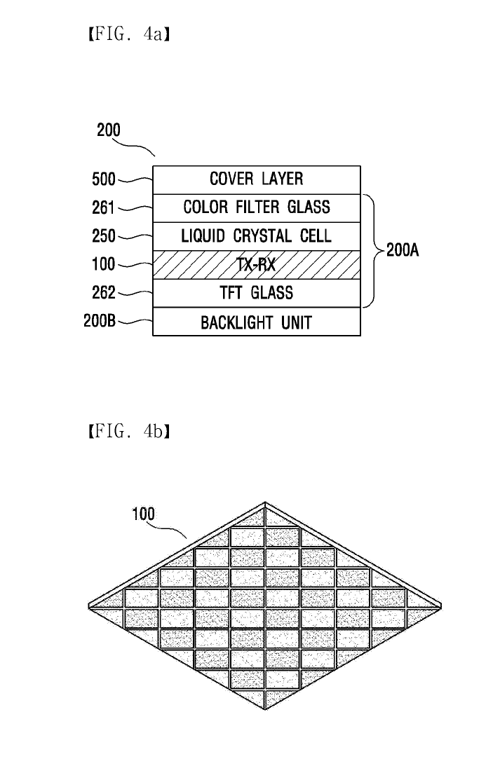

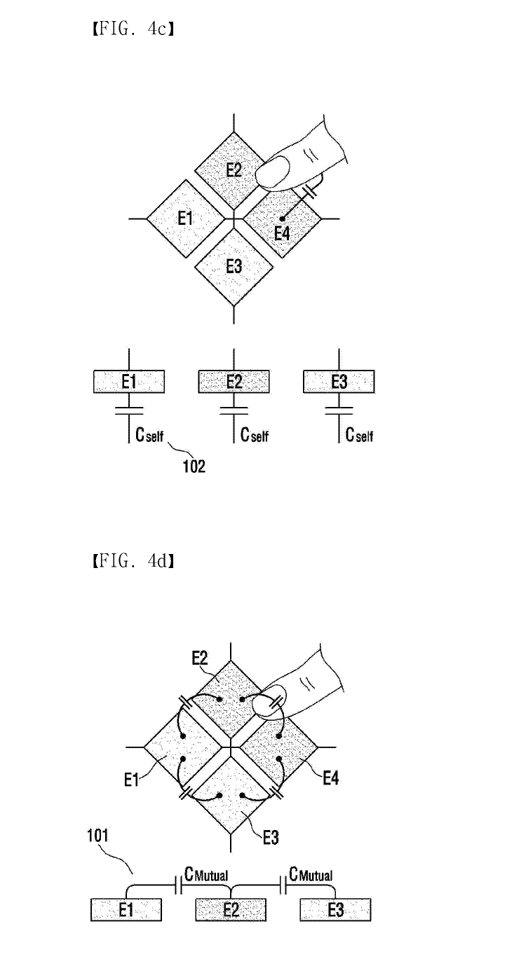

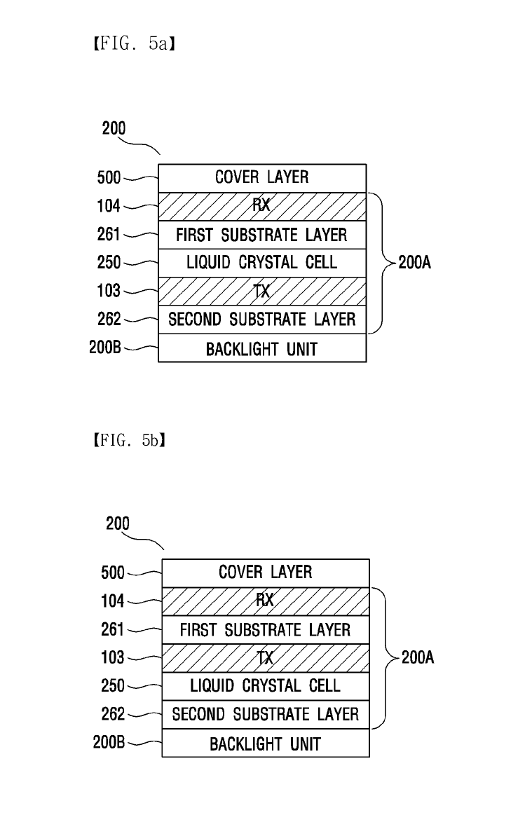

FIG. 4a shows a first example in which the touch sensor is disposed within the display module. FIG. 4a shows that the touch sensor 100 is disposed between the second substrate layer 262 and the liquid crystal cell 250 in the touch input device 1000 using the LCD panel. Therefore, FIG. 4a shows that the display module 200 includes not only the LCD panel but also a backlight unit 200B.

The display panel 200A such as an LCD panel according to the embodiment of the present invention cannot emit light itself but simply blocks or transmits the light. Therefore, the backlight unit 200B may be required. For example, the backlight unit 200B is located under the display panel 200A, includes a light source, and illuminates the display panel 200A, so that a screen displays not only brightness and darkness but information with various colors. Since the LCD panel is a passive device and cannot emit the light in itself, a light source having a uniform luminance distribution is required on the rear side.

The structures and functions of the LCD panel 200A and the backlight unit 200B have been already known to the public and will be briefly described below. The backlight unit 200B may include several optical parts.

For example, the optical layer of the backlight unit 200B may include a reflective sheet, a light guide plate, a diffuser sheet, and a prism sheet. Here, the backlight unit 200B include a light source (not shown) which is formed in the form of a linear light source or point light source and is disposed on the rear surface and/or side surface of the light guide plate.

The light guide plate may generally convert lights from the light source in the form of a linear light source or point light source into light from a light source in the form of a surface light source, and allow the light to proceed to the LCD panel. A part of the light emitted from the light guide plate may be emitted to a side opposite to the LCD panel and be lost. The reflective sheet may be positioned under the light guide plate so as to cause the lost light to be incident again on the light guide plate, and may be made of a material having a high reflectance.

The diffuser sheet functions to diffuse the light incident from the light guide plate.

For example, light scattered by the pattern of the light guide plate comes directly into the eyes of the user, and thus, the pattern of the light guide plate may be shown as it is. Moreover, since such a pattern can be clearly sensed even after the LCD panel is mounted, the diffuser sheet is able to perform a function to offset the pattern of the light guide plate.

After the light passes through the diffuser sheet, the luminance of the light is rapidly reduced. Therefore, the prism sheet may be included in order to improve the luminance of the light by focusing the light again. The prism sheet may include, for example, a horizontal prism sheet and a vertical prism sheet.

The backlight unit 200B according to the embodiment of the present invention may include a configuration different from the above-described configuration in accordance with the technical change and development and/or the embodiment. The backlight unit 200B may further include an additional configuration as well as the foregoing configuration. Also, in order to protect the optical configuration of the backlight unit 200B from external impacts and contamination, etc., due to the introduction of the alien substance, the backlight unit 200B according to the embodiment of the present may further include, for example, a protection sheet on the prism sheet. The backlight unit 200B may also further include a lamp cover in accordance with the embodiment so as to minimize the optical loss of the light source. The backlight unit 200B may also further include a frame which maintains a shape enabling the light guide plate, the diffuser sheet, and the lamp, etc., which are main components of the backlight unit 200B, to be exactly combined together in accordance with an allowed dimension. Also, the each of the components may be comprised of at least two separate parts.

In the first example of the present invention, the inner electrode included in the conventional LCD panel may be used as the touch sensor 100. Also, in the first example of the present invention, an additional electrode may be disposed within the LCD panel and be used as the touch sensor 100. FIG. 4a shows a cover layer 500 on the display panel 200A. The cover layer 500 can perform a function of protecting the display panel 200A. In the embodiment, the cover layer 500 may be made of a transparent material capable of not only protecting the display panel 200A from external environment but also causing the display screen to be visually checked. For example, the cover layer 500 may be composed of a material such as glass or plastic or may be possibly composed of materials other than glass/plastic in accordance with the embodiment of the present invention.

FIG. 4b shows the arrangement of the touch sensor 100, which can be applied to the first example shown in FIG. 4a. For example, as shown in FIG. 4b, a plurality of electrodes constituting the touch sensor 100 may be arranged in the same layer. Each rectangular component may be the electrode constituting the touch sensor.

FIG. 4c is a conceptual view for describing a first principle of detecting the touch position, which can be applied to the touch sensor arrangement shown in FIG. 4b. A part of the configuration of the touch sensor 100 is enlarged and shown in the upper part of FIG. 4c. According to the first principle, respective electrodes E1 to E4 included in the touch sensor 100 shown in FIG. 4b may be configured to detect the self-capacitance. For instance, the touch by the object or by the approach of the object can be detected by detecting the capacitance (Cself) 102 of each of the electrodes E1 to E4 for the reference potential layer (not shown) which may be any potential or a ground potential. Here, the drive signal may be applied to each of the electrodes E1 to E4 constituting the touch sensor 100 and the receiving signal may be detected from the same electrodes E1 to E4. Here, the electrode constituting the touch sensor 100 may be the conventional electrode included in the display panel 200A or may be an electrode which is additionally disposed in the display panel 200A. The first principle of detecting the touch position, which is described with reference to FIG. 4c, is the same as what has been described with reference to FIG. 1b. Here, needless to say, the touch sensor 100 may be disposed as shown in FIG. 1b as well as in FIG. 4b.

FIG. 4d is a conceptual view for describing a second principle of detecting the touch position, which can be applied to the touch sensor arrangement shown in FIG. 4b. According to the second principle, electrodes E1 and E4 electrically connected to each other on a first axis among the electrodes E1 to E4 included in the touch sensor 100 shown in FIG. 4b may function as the drive electrode. The electrode E2 and E3 electrically connected to each other on a second axis crossing the first axis may function as the receiving electrode. Here, the drive electrode and the receiving electrode can be replaced with each other. As described with reference to FIG. 1a, by detecting the mutual capacitance 101 between the drive electrode TX and the receiving electrode RX, it is possible to detect whether the touch occurs or not and the touch position. When the touch position is detected in accordance with the second principle, the drive electrode TX and the receiving electrode RX may be disposed in different layers. Also, according to the embodiment, at least one of the drive electrode TX and the receiving electrode RX may be the conventional electrode included within the display panel 200A. Also, according to the embodiment, at least one of the drive electrode TX and the receiving electrode RX may be disposed outside the display panel 200A. Also, according to the embodiment, at least one of the drive electrode TX and the receiving electrode RX may be included between the first substrate layer 261 and the second substrate layer 262, which are included in the display panel 200A. Here, the other one of the drive electrode TX and the receiving electrode RX may be disposed within the display panel 200A and at a position other than between the first substrate layer 261 and the second substrate layer 262.

FIGS. 5a and 5b show a second example and a third example in which the touch sensor is disposed within the display module.

In the second example shown in FIG. 5a, the drive electrode TX of the touch sensor 100 may be disposed between the liquid crystal layer 250 and the second substrate layer 262, and the receiving electrode RX may be disposed between the first substrate layer 261 and the cover layer 500. In the second example, the position of the drive electrode TX and the position of the receiving electrode RX can be replaced with each other. In the second example, the drive electrode TX and the receiving electrode RX may be arranged as shown in Fig. la. In the second example, the conventional electrode included in the display panel 200A or the electrode additionally disposed in the display panel 200A may be used as the drive electrode TX. An electrode additionally disposed on the first substrate layer 261 may be used as the receiving electrode RX.

The third example shown in FIG. 5 is the same as the second example with the exception of the fact that the drive electrode TX of the touch sensor 100 is disposed between the liquid crystal layer 250 and the first substrate layer 261. Therefore, repetitive descriptions thereof will be omitted. In the third example according to the embodiment, any one of the receiving electrode RX and the drive electrode TX may be additionally disposed on the front side of the first substrate layer 261, and the other one of the receiving electrode RX and the drive electrode TX may be additionally disposed on the rear side of the first substrate layer 261. According to the embodiment, the conventional electrode included within the display panel 200A can function as one of the drive electrode TX and the receiving electrode RX.

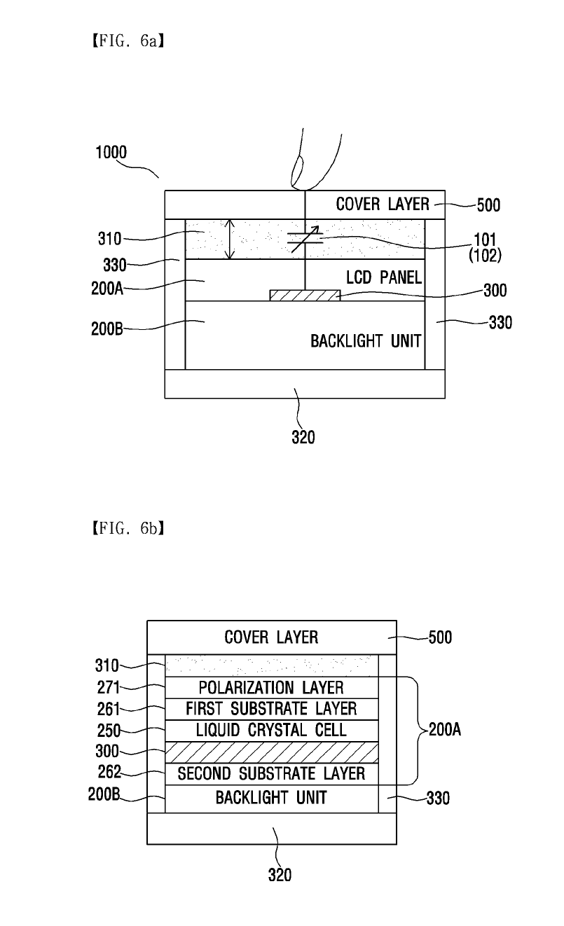

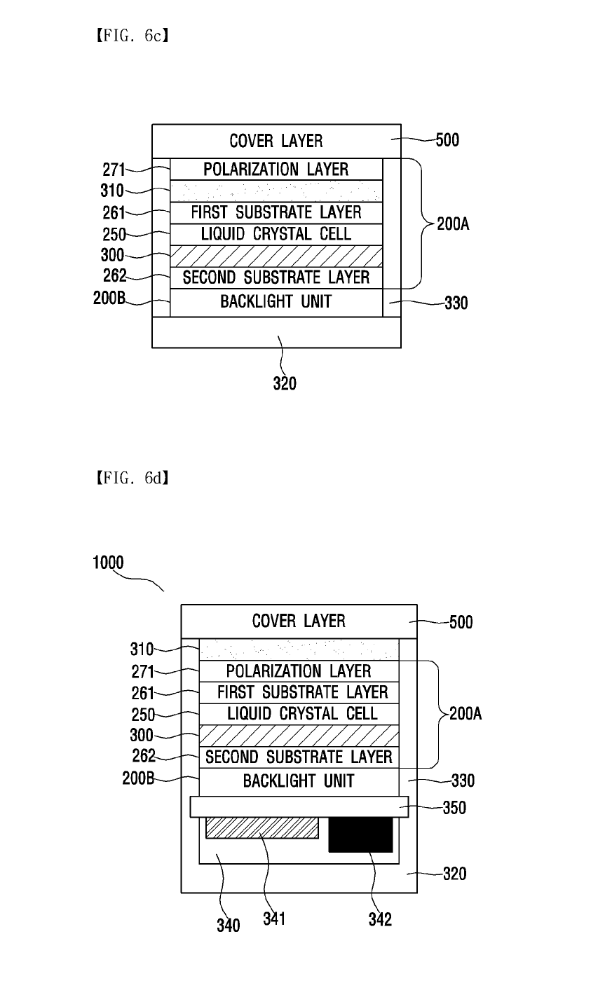

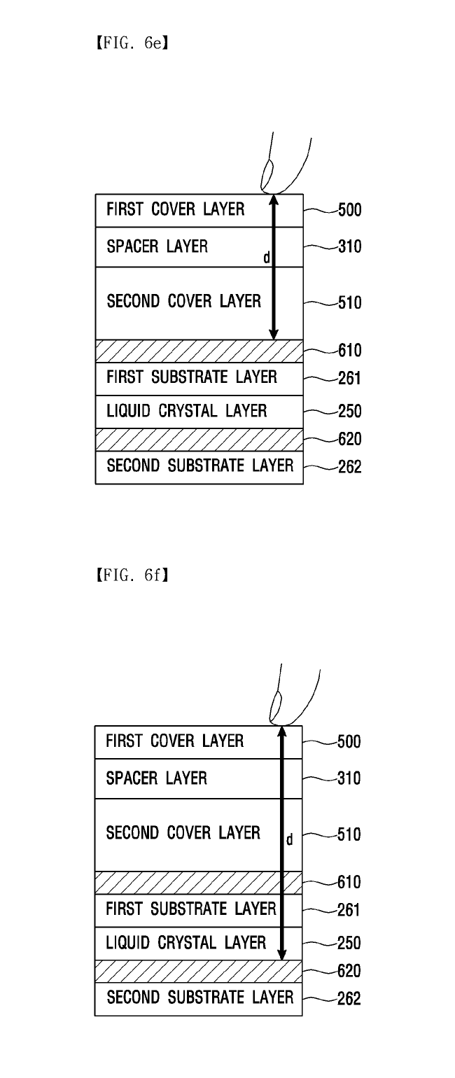

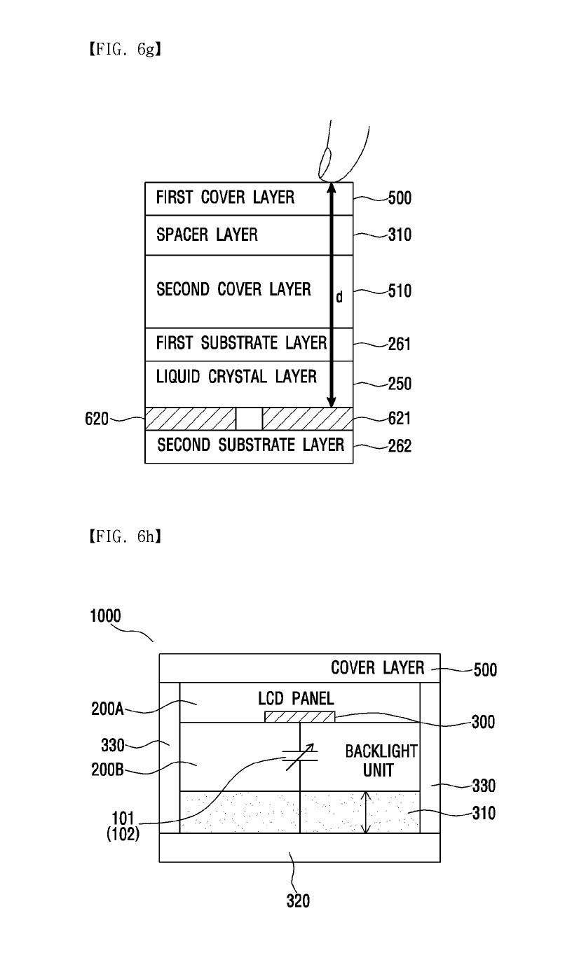

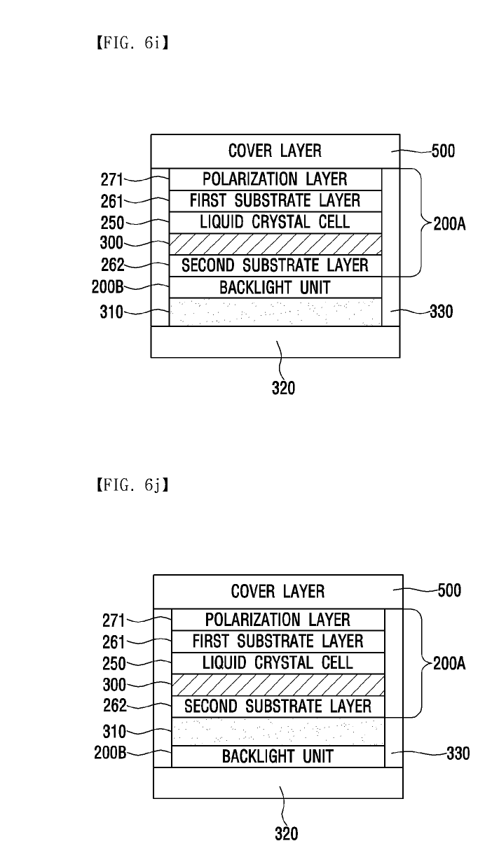

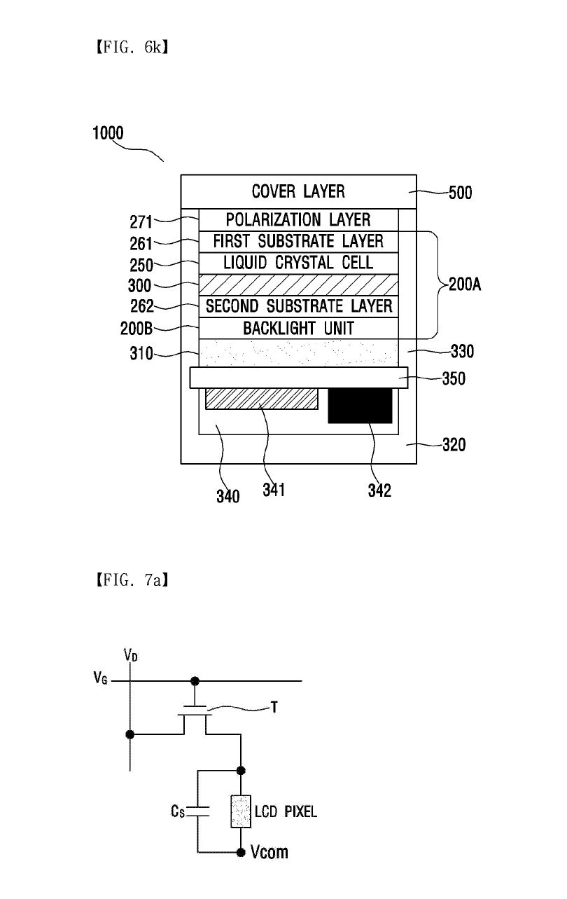

FIG. 6a shows the touch input device according to a first embodiment of the present invention. The first embodiment shown in FIG. 6a may be applied to the touch input device 1000 having the arrangement of the touch sensor 100 shown in FIGS. 3a to 3c, 4a, 5a, and 5b. As shown in FIG. 6a, in the first embodiment of the present invention, a pressure sensor 300 may be included within the LCD panel. In the first embodiment of the present invention, the electrode which is used as the touch sensor 100 can function as the pressure sensor 300. Here, the electrode which functions as the pressure sensor 300 may be an electrode disposed additionally for touch sensing. Further, according to the embodiment, the conventional electrode included within the LCD panel may be used as the pressure sensor 300.

The structure of the touch input device 1000 shown in FIG. 6a according to the first embodiment of the present invention, which is applied when the reference potential is the object, will be briefly described.

As shown in FIG. 6a, the touch input device 1000 according to the first embodiment of the present invention may include the display panel 200A, the backlight unit 200B disposed under the display panel 200A, the cover layer 500 disposed on the display panel 200A, and the spacer layer 310 disposed between the cover layer 500 and the display panel 200A. In the touch input device 1000 according to the first embodiment, the display module 200 may be surrounded by a first support member 320, a second support member 330, and the cover layer 500. In this specification, the display panel 200A and the backlight unit 200B may be collectively referred to as the display module 200.

According to the embodiment, the first support member 320 may be a frame made of metal. The first support member 320 may be formed to be included in the backlight unit 200B when the backlight unit 200B is manufactured. The first support member 320 may be relatively less bent than the cover layer even when pressure is applied and may function as a support. According to the embodiment, the first support member 320 may be manufactured separately from the backlight unit 200B and assembled together with the backlight unit 200B when the display module 200 is manufactured.

The touch input device 1000 according to the embodiment may further include the second support member 330 such that the display panel 200A, the backlight unit 200B, and the cover layer 500 are combined and maintain a fixed shape. According to the embodiment, the first support member 320 may be integrally formed with the second support member 330. According to the embodiment, the second support member 330 may form a part of the backlight unit 200B.

Referring to FIG. 6A, a principle of detecting the touch pressure in the touch input device 1000 according to the first embodiment of the present invention will be described first. The spacer layer 310 may be disposed between the pressure sensor 300 and the object.

According to the embodiment, the spacer layer may be implemented by an air gap. According to the embodiment, the spacer layer may be made of an impact absorbing material. According to the embodiment, the spacer layer may be filled with a dielectric material. According to the embodiment, the spacer layer 310 may be made of a material having a restoring force by which the material contracts by applying the pressure and returns to its original shape by releasing the pressure. According to the embodiment, the spacer layer 310 may be made of elastic foam.

Accordingly, when the cover layer 500 is bent by applying pressure to the surface of the cover layer 500 by the object, the spacer layer 310 is pressed, and thus, a relative distance between the pressure sensor 300 and the object may be reduced.

In the touch input device 1000 according to the embodiment, the cover layer 500 may be bent or pressed by the touch applying the pressure. The cover layer may be bent or pressed to show the largest deformation at the touch position. When the cover layer is bent or pressed according to the embodiment, a position showing the largest deformation may not match the touch position. However, the cover layer may be at least shown to be bent or pressed by the touch. For example, when the touch position approaches close to the border, edge, etc., of the cover layer, the most bent or pressed position of the cover layer may not match the touch position.

When the cover layer 500 is bent or pressed by touching the touch input device 1000 according to the embodiment, the display module 200 located under the spacer layer 310 may be less bent or pressed by the spacer layer 310. According to the embodiment, the display module 200 may not be bent or pressed at all when the pressure is applied.

The relative distance between the pressure sensor 300 and the object may be reduced by applying pressure to the touch input device 1000 as shown in FIG. 6a. The magnitude of the touch pressure can be detected based on the magnitude of the capacitance detected from the pressure sensor 300, which changes in accordance with the distance reduction.

For example, as described with reference to FIG. 4d, the magnitude of the touch pressure can be detected through the mutual capacitance between the drive electrode TX and the receiving electrode RX. In this case, the pressure sensor 300 may include the drive electrode TX and the receiving electrode RX which are disposed on the same plane as shown in FIG. 4d. A mutual capacitance may be formed between the drive electrode TX and the receiving electrode RX. Also, according to the embodiment, the pressure sensor 300 may include the drive electrode TX and the receiving electrode RX which are disposed in different layers.

Here, the object may have any potential. For example, the object may be a finger having a ground potential. According to the embodiment, the object may be a conductive rod having any potential such as a stylus pen.

Here, as the distance between the object and the pressure sensor 300 reduces, the value of the mutual capacitance between the drive electrode TX and the receiving electrode RX constituting the pressure sensor 300 may decrease. This is because the distance between the object and the drive electrode TX and the receiving electrode RX is reduced from d to d′, so that a fringing capacitance of the mutual capacitance between the drive electrode TX and the receiving electrode RX is absorbed by the object.

Also, in the embodiment of the present invention, as described with reference to FIG. 4c, the magnitude of the touch pressure can be detected through the self-capacitance of the electrode to the object. In this case, as shown in FIGS. 1b and 4b, the pressure sensor 300 may be configured to include one or more single electrodes disposed on the same plane. The magnitude of the touch pressure can be detected by detecting the self-capacitance of the single electrode to the object.

Since the distance d between the object and the pressure sensor 300 decreases as the touch pressure which is applied to the touch input device 1000 increases, the self-capacitance of the single electrode to the object may increase as the touch pressure increases.

According to the embodiment, the touch pressure with a sufficiently large magnitude makes a state where the distance between the object and the pressure sensor 300 cannot be reduced any more at a predetermined position. Hereafter, such a state is referred to as a saturation state. However, even in such a case, when the magnitude of the touch pressure becomes larger, the area in the saturation state where the distance between the object and the pressure sensor 300 cannot be reduced any more may become greater. As such a saturation area increases, the mutual capacitance between the drive electrode TX and the receiving electrode RX may decrease. Also, as the saturation area increases, the self-capacitance through the single electrode may increase. As the saturation area increases, the mutual capacitance for one node is not reduced any more or the self-capacitance for one node is not increased any more, and the number of nodes where the mutual capacitance or the self-capacitance changes may increase. Here, the touch area can be obtained through the number of nodes where the mutual capacitance or the self-capacitance changes. Hereinafter, it will be described that the magnitude of the touch pressure is calculated by the change of the capacitance according to the distance change. This may include that the magnitude of the touch pressure is calculated by the change of the saturation area in the saturation state.

FIGS. 6b to 6g show respectively the structure of the touch input device according to the first embodiment of the present invention shown in FIG. 6a. FIGS. 6b to 6d show the detailed structure of the first embodiment shown in FIG. 6a, and only differences from FIG. 6a will be described.

FIG. 6b shows that the pressure sensor 300 is disposed between the liquid crystal cell 250 and the second substrate layer 262. Here, the pressure sensor 300 may be an electrode formed on the second substrate layer 262. Various electrodes for the operation of the display panel 200A may be formed at the second substrate layer 262. In FIG. 6b, the spacer layer 310 is disposed on the display panel 200A. More specifically, the spacer layer 310 is disposed between the display panel 200A and the cover layer 500.

FIG. 6c shows that the pressure sensor 300 is, as shown in FIG. 6b, disposed between the liquid crystal cell 250 and the second substrate layer 262 and the spacer layer 310 is disposed within the display panel 200A. Here, the spacer layer 310 may be composed of an air gap such that light from the backlight unit 200B can be transmitted without loss to the outside. As described above, the spacer layer 310 shown in FIG. 6c may be the additionally formed air gap, or may be an air gap included in the manufacture of the display panel 200A according to the embodiment.

FIG. 6d shows that an intermediate frame 350 is further included under the display module 200. The intermediate frame 350 in the touch input device 1000 according to the embodiment of the present invention, together with the outermost mechanism or the first support member 320 of the touch input device 1000, can perform a housing function of surrounding a mounting space 340, etc., where a circuit board 341 and/or a battery for operation of the touch input device 1000 can be positioned. Here, the circuit board for operation of the touch input device 1000 may be a main board. A central processing unit (CPU), an application processor (AP) or the like may be mounted on the main board. Due to the intermediate frame 350, the display module 200 is separated from the circuit board and/or battery for operation of the touch input device 1000. Due to the intermediate frame 350, electrical noise generated from the display module 200 can be blocked.

In FIGS. 6a to 6d, one cover layer and the spacer layer 310 disposed under the cover layer have been described. In addition to this, an additional cover layer may be further included. Specifically, a second cover layer 510 may be disposed under the first cover layer 500, and the spacer layer 310 may be disposed between the first cover layer 500 and the second cover layer 510. Here, the second cover layer 510 may also be made of a transparent material-made glass or plastic, etc., such that an image output from the display module 200 disposed under the cover layer is visible to the outside. The second cover layer 510 may be made of a material which is relatively harder than that of the first cover layer 500 or may be formed thicker than the first cover layer 500 such that the second cover layer 510 is relatively less bent than the first cover layer 500 even when pressure is applied to the second cover layer 510. In this case, the structure following the second cover layer 510 is the same as that of the conventional touch input device which does not detect the touch pressure. Therefore, by adding a module composed of the first cover layer 500 and the spacer layer 310 to the conventional touch input device, the touch input device capable of detecting touch pressure can be implemented. Accordingly, there is no need to change the structure of the conventional touch input device and reliability can be easily obtained. Further, the module composed of the first cover layer 500 and the spacer layer 310 is completely separated from the display module 200. Therefore, there is an advantage that they can be replaced separately from each other.

FIGS. 6e and 6f are cross sectional views of a touch input device according to further another embodiment of the present invention. For example, the touch input device shown in FIGS. 6e and 6f may include the first cover layer 500, the spacer layer 310 disposed under the first cover layer 500, the second cover layer 510 disposed under the spacer layer 310, the display module disposed under the second cover layer 510, and the first electrode 620 and the third electrode 610 which are disposed on the display module. The display module may include the first substrate layer 261 and the second substrate layer 262 disposed under the first substrate layer 261. The third electrode 610 may be disposed on the first substrate layer 261, and the first electrode 620 may be disposed on the second substrate layer 262.

As shown in FIG. 6e, the drive unit 120 according to the embodiment of the present invention may apply a touch position drive signal to the first electrode 620 and may apply a touch pressure drive signal to the third electrode 610. The sensing unit 110 may receive a touch position sensing signal from the third electrode 610 and may receive a touch pressure sensing signal from the third electrode 610.

As described in FIG. 1a, the touch position sensing signal including information on the mutual capacitance between the first electrode 620 and the third electrode 610, which changes according to the touch on the surface of the first cover layer 500, is received by the sensing unit 110 from the third electrode 610. Thus, the touch position can be detected.

When pressure is applied to the first cover layer 500 by the object, the spacer layer 310 is compressed, thereby reducing the distance between the object and the third electrode 610. Here, if the object serves as a ground (reference potential), the self-capacitance of the third electrode 610 changes according to the distance change between the object and the third electrode 610. Therefore, the touch pressure sensing signal including information on the self-capacitance of the third electrode 610, which changes according to the pressure applied to the first cover layer 500 is received by the sensing unit 110 from the third electrode 610. Thus, the touch pressure can be detected.

The controller 130 may time-divide the time for applying the drive signal to the first electrode 620 and the third electrode 610 and then may apply the touch position drive signal to the first electrode 620 in the first time interval, and may apply the touch pressure drive signal to the third electrode 610 in the second time interval different from the first time interval. In this case, the controller 130 can control the sensing unit 110 such that the touch position sensing signal is received from the third electrode 610 in the first time interval and the touch pressure sensing signal is received from the third electrode 610 in the second time interval.

As shown in FIG. 6f, the drive unit 120 according to the embodiment of the present invention may apply the touch position drive signal and the touch pressure drive signal to the first electrode 620. The sensing unit 110 may receive the touch position sensing signal from the third electrode 610 and may receive the touch pressure sensing signal from the first electrode 620.

As described in FIG. 1a, the touch position sensing signal including information on the mutual capacitance between the first electrode 620 and the third electrode 610, which changes according to the touch on the surface of the first cover layer 500 is received by the sensing unit 110 from the third electrode 610. Thus, the touch position can be detected.

When pressure is applied to the first cover layer 500 by the object, the spacer layer 310 is compressed, thereby reducing the distance between the object and the first electrode 620. Here, if the object serves as a ground (reference potential), the self-capacitance of the first electrode 620 changes according to the distance change between the object and the first electrode 620. Therefore, the touch pressure sensing signal including information on the self-capacitance of the first electrode 620, which changes according to the pressure applied to the first cover layer 500, is received by the sensing unit 110 from the first electrode 620. Thus, the touch pressure can be detected.

The controller 130 may time-divide the time for applying the drive signal to the first electrode 620 and then may apply the touch position drive signal to the first electrode 620 in the first time interval, and may apply the touch pressure drive signal to the first electrode 620 in the second time interval different from the first time interval. In this case, the controller 130 may control the sensing unit 110 such that the touch position sensing signal is received from the third electrode 610 in the first time interval and the touch pressure sensing signal is received from the first electrode 620 in the second time interval.

Here, the controller 130 may control the third electrode 610 to be floating or to have high impedance in the second time interval. When the third electrode 610 is floating or has high impedance in the second time interval, the self-capacitance of the first electrode 620 can be more easily sensed.

FIG. 6g is a cross sectional view of a touch input device according to yet another embodiment of the present invention. For example, the touch input device shown in FIG. 6g may include the first cover layer 500, the spacer layer 310 disposed under the first cover layer 500, the second cover layer 510 disposed under the spacer layer 310, the display module disposed under the second cover layer 510, and the first electrode 620 and the third electrode 610 which are disposed on the display module. The display module may include the first substrate layer 261 and the second substrate layer 262 disposed under the first substrate layer 261. The first electrode 620 and the third electrode 610 may be disposed on the second substrate layer 262.

As shown in FIG. 6g, the drive unit 120 according to the embodiment of the present invention may apply the touch position drive signal to the first electrode 620 and may apply the touch pressure drive signal to the second electrode 621. The sensing unit 110 may receive the touch position sensing signal from the second electrode 621 and may receive the touch pressure sensing signal from the second electrode 621.

As described in FIG. 1a, the touch position sensing signal including information on the mutual capacitance between the first electrode 620 and the second electrode 621, which changes according to the touch on the surface of the first cover layer 500, is received by the sensing unit 110 from the second electrode 621. Thus, the touch position can be detected.

When pressure is applied to the first cover layer 500 by the object, the spacer layer 310 is compressed, thereby reducing the distance between the object and the second electrode 621. Here, if the object serves as a ground (reference potential), the self-capacitance of the second electrode 621 changes according to the distance change between the object and the second electrode 621. Therefore, the touch pressure sensing signal including information on the self-capacitance of the second electrode 621, which changes according to the pressure applied to the first cover layer 500 is received by the sensing unit 110 from the second electrode 621. Thus, the touch pressure can be detected.

The controller 130 can control the drive unit 120 such that the time for applying the drive signal to the first electrode 620 and to the second electrode 621 is time-divided and the touch position drive signal is applied to the first electrode 620 in the first time interval and the touch pressure drive signal is applied to the second electrode 621 in the second time interval different from the first time interval. In this case, the controller 130 can control the sensing unit 110 such that the touch position sensing signal is received from the second electrode 621 in the first time interval and the touch pressure sensing signal is received from the second electrode 621 in the second time interval.

As shown in FIG. 6g, the drive unit 120 according to the embodiment of the present invention may apply the touch position drive signal to the first electrode 620 and the second electrode 621 and may apply the touch pressure drive signal to the first electrode 620 and/or the second electrode 621. The sensing unit 110 may receive the touch position sensing signal from the first electrode 620 and the second electrode 621, and may receive the touch pressure sensing signal from the first electrode 620 and/or the second electrode 621.

As described in FIG. 1b, the touch position sensing signal including information on the self-capacitance each of the first electrode 620 and the second electrode 621, which changes according to the touch on the surface of the first cover layer 500, is received by the sensing unit 110 from each of the first electrode 620 and the second electrode 621. Thus, the touch position can be detected.

When pressure is applied to the first cover layer 500 by the object, the spacer layer 310 is compressed, thereby reducing the distance between the object and the first electrode 620 and/or the distance between the object and the second electrode 621. Here, if the object serves as a ground (reference potential), the self-capacitance of the first electrode 620 changes according to the distance change between the object and the first electrode 620 and/or the self-capacitance of the second electrode 621 changes according to the distance change between the object and the second electrode 621. Therefore, the touch pressure sensing signal including information on the self-capacitance of the first electrode 620, which changes according to the pressure applied to the first cover layer 500, is received by the sensing unit 110 from the first electrode 620, and/or the touch pressure sensing signal including information on the self-capacitance of the second electrode 621 is received by the sensing unit 110 from the second electrode 621. Thus, the touch pressure can be detected.

The controller 130 can control the sensing unit 110 such that the time for detecting the sensing signal from the first electrode 620 and the second electrode 621 is time-divided and the touch position sensing signal is received from the first electrode 620 and the second electrode 621 in the first time interval and the touch pressure sensing signal is received from the first electrode 620 and/or the second electrode 621 in the second time interval different from the first time interval. In this case, the controller 130 can control the drive unit 120 such that the touch position drive signal is applied to the first electrode 620 and the second electrode 621 in the first time interval and the touch pressure drive signal is applied to the first electrode 620 and/or the second electrode 621 in the second time interval.

FIG. 6h shows another touch input device according to the first embodiment of the present invention. The first embodiment shown in FIG. 6h may be applied to the touch input device 1000 having the arrangement of the touch sensor 100 shown in FIGS. 3a to 3c, 4a, 5a, and 5b. As shown in FIG. 6h, in the first embodiment of the present invention, the pressure sensor 300 may be included within the LCD panel. The electrode used as the touch sensor 100 in the first embodiment of the present invention can function as the pressure sensor 300. Here, the electrode functioning as the pressure sensor 300 may be an electrode further disposed for touch sensing. Alternatively, according to the embodiment, the conventional electrode included within the LCD panel may be used as the pressure sensor 300.

The structure of the touch input device 1000 according to the first embodiment of the present invention shown in FIG. 6h, which is applied when the reference potential is spaced from the pressure sensor and is a reference potential layer located on, under or within the display panel 200A will be briefly described.

As shown in FIG. 6h, the touch input device 1000 according to the first embodiment of the present invention may include the display panel 200A, the backlight unit 200B disposed under the display panel 200A, and the cover layer 500 disposed on the display panel 200A. In the touch input device 1000 according to the first embodiment, the display module 200 may be surrounded by the first support member 320, the second support member 330, and the cover layer 500. In this specification, the display panel 200A and the backlight unit 200B may be collectively referred to as the display module 200.

According to the embodiment, the first support member 320 may be a frame made of metal. The first support member 320 may be formed to be included in the backlight unit 200B when the backlight unit 200B is manufactured. The first support member 320 may be relatively less bent than the cover layer, the display panel 200A, and/or the display module 200 and the like even when pressure is applied and may function as a support. According to the embodiment, the first support member 320 may be manufactured separately from the backlight unit 200B and assembled together with the backlight unit 200B when the display module 200 is manufactured.

The touch input device 1000 according to the embodiment may further include the second support member 330 such that the display panel 200A, the backlight unit 200B, and the cover layer 500 are combined and maintain a fixed shape. According to the embodiment, the first support member 320 may be integrally formed with the second support member 330. According to the embodiment, the second support member 330 may form a part of the backlight unit 200B.

Hereinafter, the first embodiment of the present invention will be described by taking an example in which the first support member 320 is used as a reference potential layer.

Referring to FIG. 6h, the principle of detecting the touch pressure in the touch input device 1000 according to the first embodiment of the present invention will be described first. The pressure sensor 300 may be disposed apart from the reference potential layer 320. The spacer layer 310 may be disposed between the pressure sensor 300 and the reference potential layer 320.

According to the embodiment, the spacer layer may be implemented by an air gap. According to the embodiment, the spacer layer may be made of an impact absorbing material. According to the embodiment, the spacer layer may be filled with a dielectric material. According to the embodiment, the spacer layer 310 may be made of a material having a restoring force by which the material contracts by applying the pressure and returns to its original shape by releasing the pressure. According to the embodiment, the spacer layer 310 may be made of elastic foam.

According to the embodiment, the spacer layer 310 may be the air gap which is included during the manufacture of the display panel 200A and/or the backlight unit 200B. When the display panel 200A and/or the backlight unit 200B include one air gap, the one air gap may function as the spacer layer. When the display panel 200A and/or the backlight unit 200B include a plurality of the air gaps, the plurality of air gaps may collectively function as the spacer layer. FIG. 6h shows that the spacer layer 310 is disposed between the backlight unit 200B and the reference potential layer 320.

Accordingly, when the cover layer 500 and the display module 200 are bent by applying pressure to the surface of the cover layer 500, the spacer layer 310 is pressed, and thus, a relative distance between the pressure sensor 300 and the reference potential layer 320 may be reduced.

In the touch input device 1000 according to the embodiment, the display module 200 may be bent or pressed by the touch applying the pressure. The display module may be bent or pressed to show the largest deformation at the touch position. When the display module is bent or pressed according to the embodiment, a position showing the largest deformation may not match the touch position. However, the display module may be at least shown to be bent or pressed by the touch. For example, when the touch position approaches close to the border, edge, etc., of the display module, the most bent or pressed position of the display module may not match the touch position.

When the cover layer 500, the display panel 200A, and/or the backlight unit 200B are bent or pressed by touching the touch input device 1000 according to the embodiment, the reference potential layer 320 located under the spacer layer 310 may be less bent or pressed by the spacer layer 310. According to the embodiment, the reference potential layer 320 may not be bent or pressed at all when the pressure is applied.

The relative distance between the pressure sensor 300 and the reference potential layer 320 may be reduced by applying pressure to the touch input device 1000 as shown in FIG. 6h. The magnitude of the touch pressure can be detected based on the magnitude of the capacitance detected from the pressure sensor 300, which changes in accordance with the distance reduction.

For example, as described with reference to FIG. 4d, the magnitude of the touch pressure can be detected through the mutual capacitance between the drive electrode TX and the receiving electrode RX. In this case, the pressure sensor 300 may include the drive electrode TX and the receiving electrode RX which are disposed on the same plane as shown in FIG. 4d. A mutual capacitance may be formed between the drive electrode TX and the receiving electrode RX. Also, according to the embodiment, the pressure sensor 300 may include the drive electrode TX and the receiving electrode RX which are disposed in different layers.

Here, the reference potential layer 320 may have any potential to cause change of the mutual capacitance formed between the drive electrode TX and the receiving electrode RX. For example, the reference potential layer 320 may be a ground layer having a ground potential. The reference potential layer 320 may be any ground layer included within the touch input device 1000. According to the embodiment, the reference potential layer 320 may be a ground potential layer which is in itself included in the manufacture of the touch input device 1000.

Here, as the distance between the reference potential layer 320 and the pressure sensor 300 reduces, the value of the mutual capacitance between the drive electrode TX and the receiving electrode RX constituting the pressure sensor 300 may decrease. This is because the distance between the reference potential layer 320 and the drive electrode TX and the receiving electrode RX is reduced from d to d′, so that a fringing capacitance of the mutual capacitance between the drive electrode TX and the receiving electrode RX is absorbed not only by the object but by the reference potential layer 320. When the touch object is non-conductive, the mutual capacitance change may simply result only from the distance change (d-d′) between the reference potential layer 320 and the pressure sensor 300.

Also, in the embodiment of the present invention, as described with reference to FIG. 4c, the magnitude of the touch pressure can be detected through the self-capacitance of the electrode to the reference potential layer 320. In this case, as shown in FIGS. 1b and 4b, the pressure sensor 300 may be configured to include one or more single electrodes disposed on the same plane. The magnitude of the touch pressure can be detected by detecting the self-capacitance of the single electrode to the reference potential layer 320.

Since the distance d between the reference potential layer 320 and the pressure sensor 300 decreases as the touch pressure which is applied to the touch input device 1000 increases, the self-capacitance of the single electrode to the reference potential layer 320 may increase as the touch pressure increases.

According to the embodiment, the touch pressure with a sufficiently large magnitude makes a state where the distance between the reference potential layer 320 and the pressure sensor 300 cannot be reduced any more at a predetermined position. Hereafter, such a state is referred to as a saturation state. However, even in such a case, when the magnitude of the touch pressure becomes larger, the area in the saturation state where the distance between the reference potential layer 320 and the pressure sensor 300 cannot be reduced any more may become greater. As such a saturation area increases, the mutual capacitance between the drive electrode TX and the receiving electrode RX may decrease. Also, as the saturation area increases, the self-capacitance through the single electrode may increase. As the saturation area increases, the mutual capacitance for one node is not reduced any more or the self-capacitance for one node is not increased any more, and the number of nodes where the mutual capacitance or the self-capacitance changes may increase. Here, the touch area can be obtained through the number of nodes where the mutual capacitance or the self-capacitance changes. Hereinafter, it will be described that the magnitude of the touch pressure is calculated by the change of the capacitance according to the distance change. This may include that the magnitude of the touch pressure is calculated by the change of the saturation area in the saturation state.

FIGS. 6i to 6k show respectively the structure of the touch input device according to the first embodiment of the present invention shown in FIG. 6h. FIGS. 6i to 6k show the detailed structure of the first embodiment shown in FIG. 6h, and only differences from FIG. 6h will be described.

FIG. 6i shows that the pressure sensor 300 is disposed between the liquid crystal cell 250 and the second substrate layer 262. Here, the pressure sensor 300 may be an electrode formed on the second substrate layer 262. Various electrodes for the operation of the display panel 200A may be formed at the second substrate layer 262. In FIG. 6i, the spacer layer 310 is disposed under the backlight unit 200B. More specifically, the spacer layer 310 is disposed between the backlight unit 200B and the reference potential layer 320.

FIG. 6j shows that the pressure sensor 300 is, as shown in FIG. 6i, disposed between the liquid crystal cell 250 and the second substrate layer 262 and the spacer layer 310 is disposed between the backlight unit 200B and the second substrate layer 262. In FIG. 6j, the spacer layer 310 is disposed between the display panel 200A and the backlight unit 200B. Here, the spacer layer 310 may be composed of an air gap such that light from the backlight unit 200B can be transmitted to the LCD panel without loss.

In the touch input device 1000 according to the embodiment, the air gap may be included between the display panel 200A and the backlight unit 200B. This intends to protect the display panel 200A and/or the backlight unit 200B from external impacts. This air gap may be included in the backlight unit 200B.

According to the embodiment, an additional air gap may be provided between the light guide plate and the reflective sheet which are included in the backlight unit 200B. Accordingly, lost light from the light guide plate to the reflective sheet can be incident again on the light guide plate through the reflective sheet. Here, in order to maintain the additional air gap, a double adhesive tape (DAT) may be included on the edge between the light guide plate and the reflective sheet. Also, according to the embodiment, the light guide plate and the reflective sheet may be disposed apart from each other by any other fixing member.

As described above, the spacer layer 310 shown in FIG. 6j may be the additionally formed air gap, or may be an air gap included in the manufacture of the backlight unit 200B according to the embodiment.

The case where the first support member 320 is used as the reference potential layer has been described in FIGS. 6i and 6j. In FIGS. 6i and 6j, the first support member 320 may be a portion of a metal case, a frame and/or a housing which surround the display module 200. Alternatively, the first support member 320 may be a portion of the case, the frame and/or the housing of the touch input device 1000 itself. Also, the first support member 320 may be a metal bezel included in the display module and may be connected to the ground. Here, the first support member 320 may be configured to have a ground potential or other specific potentials.

FIG. 6k shows that the intermediate frame 350 is further included under the display module 200. The intermediate frame 350 in the touch input device 1000 according to the embodiment of the present invention, together with the outermost mechanism or the first support member 320 of the touch input device 1000, can perform a housing function of surrounding the mounting space 340, etc., where the circuit board 341 and/or a battery for operation of the touch input device 1000 can be positioned. Here, the circuit board for operation of the touch input device 1000 may be a main board. A central processing unit (CPU), an application processor (AP) or the like may be mounted on the main board. Due to the intermediate frame 350, the display module 200 is separated from the circuit board and/or battery for operation of the touch input device 1000. Due to the intermediate frame 350, electrical noise generated from the display module 200 can be blocked. Here, the intermediate frame 350 may be used as the reference potential layer, and the intermediate frame 350 may be configured to have a ground potential or other specific potentials.

FIG. 7a is a display circuit structure diagram of the touch input device according to the first embodiment of the present invention. In general, each unit pixel included in the LCD panel may be composed of three sub-pixels. FIG. 7a shows an equivalent circuit for one sub-pixel. Here, the sub-pixel is represented by an LCD pixel.

FIG. 7b shows an electrical signal which is for detecting the touch position and touch pressure through the display panel of the touch input device according to the first embodiment of the present invention and is applied to the circuit structure shown in FIG. 7a.

Hereinafter, a method for detecting the touch position and the touch pressure in the touch input device 1000 according to the first embodiment of the present invention will be described with reference to FIGS. 7a and 7b. Hereinafter, it is described as an example that a common electrode Vcom which is disposed on the second substrate layer 262 or disposed at another position in accordance with the embodiment is used as the pressure sensor 300 and the touch sensor 100.

In the first embodiment of the present invention, the touch input device 1000 can operate with the distinction of a display driving time interval and a touch position/pressure detection time interval. The distinction of the time interval can be made by a control signal. For example, when the control signal is 1 (high), the display driving time interval may be displayed, and when the control signal is 0 (low), the touch position/pressure detection time interval may be displayed. The time interval can be represented by a different signal in accordance with the embodiment.

In the display driving time interval, an “ON” signal as a gate voltage VG is applied to the gate line, so that a transistor T capable of controlling the LCD pixel can be opened. Here, a required voltage is applied to the data line through the data voltage VD, and a desired voltage is charged to a storage capacitor Cs and an LC capacitor included in the LCD pixel. Accordingly, the display of the corresponding LCD pixel can be controlled.

In the touch position/pressure detection time interval, an “OFF” signal is applied as the gate voltage VG and the data line can be floating. In this case, even though voltage for sensing the touch position/touch pressure is applied to the common electrode Vcom, the voltage at the other end of the LC capacitor can be maintained constant because the voltage at the other end of the LC capacitor is in a floating state. Accordingly, the touch position/pressure can be detected through the common electrode Vcom without causing unnecessary operations on the display panel 200A.

FIG. 7b shows that the display driving time interval and the touch position/pressure detection time interval are alternately arranged. More specifically, in FIG. 7b, the control signal is applied in such a manner that the gate voltage VG1 is applied only to a first gate line during a first display driving time interval and the scanning is performed and the gate voltage VG2 is applied to a second gate line during a second display driving time interval and the scanning is performed. However, according to the embodiment, it may be possible that after the gate voltage VG is sequentially applied to all the gate lines and the scanning is completed, the touch position/pressure may be detected. That is, after the display driving is continuously performed in the entire time interval in which one frame is refreshed, the touch position/pressure can be detected in the remaining time interval. Also, the display driving time interval and the touch position/pressure detection time interval may be variously arranged according to the embodiment.

While only the case where the touch input device operates by time-dividing the display driving time interval and the touch position/pressure detection time interval has been described above, the touch position detection and the pressure detection may be made in a time-division manner in accordance with the embodiment. For example, the touch input device may operate with the distinction of the touch position detection time interval and the pressure detection time interval. According to the embodiment, the touch input device may operate in a manner in which the time is time-divided into the display driving time interval, the touch position detection time interval, and the pressure detection time interval. Also, according to the embodiment, the touch input device may operate by time-dividing the display driving time interval, the touch position detection time interval, and the pressure detection time interval in other combinations.

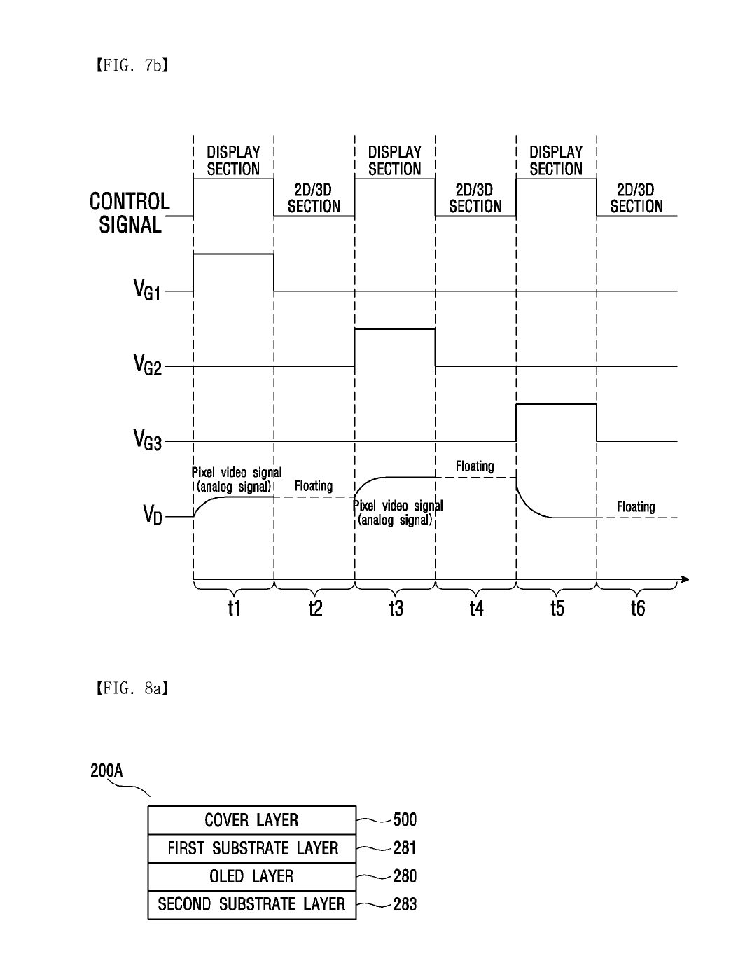

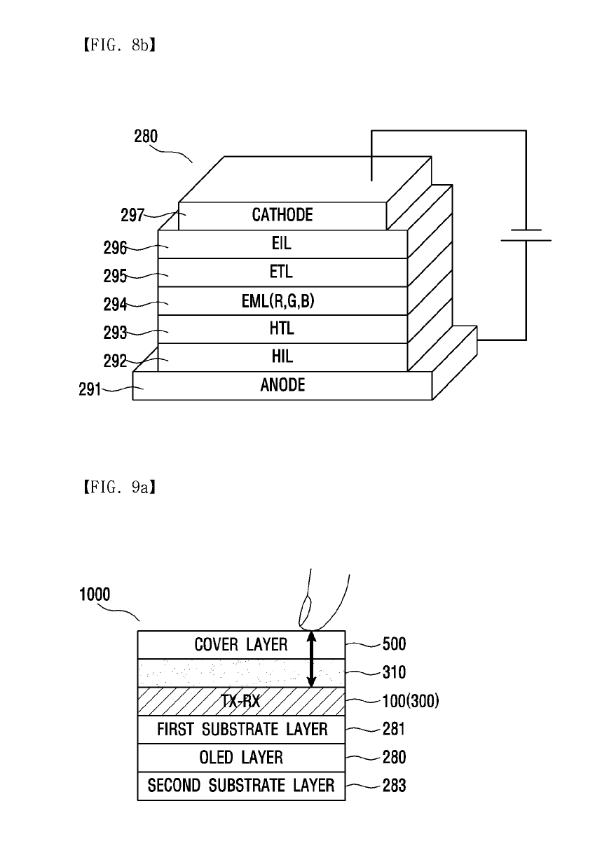

FIG. 8a shows the structure of an OLED display panel which can be applied to the embodiment of the present invention. As described with reference to FIGS. 3d and 3f, the OLED display panel 200A which can be applied to the embodiment of the present invention includes encapsulation glass as the first substrate layer 281, the OLED layer 280, and TFT glass as the second substrate layer 283. However, the embodiment of the present invention is not limited to this.

FIG. 8b shows the structure of the OLED layer included in the OLED display panel shown in FIG. 8a.

The OLED layer 280 may include a hole injection layer (HIL) 292, a hole transport layer (HTL) 293, an electron injection layer (EIL) 296, an electron transport layer (ETL) 295, and an light-emitting layer (EML) 294.

Briefly describing each of the layers, HIL 292 injects electron holes and is made of a material such as copper phthalocyanine (CuPc), etc. HTL 293 functions to move the injected electron holes and mainly is made of a material having a good hole mobility. The HTL 293 may be made of Arylamine, TPD, and the like. The EIL 296 and ETL 295 inject and transport electrons. The injected electrons and electron holes are combined in the EML 294 and emit light. The EML represents the color of the emitted light and is composed of a host determining the lifespan of the organic matter and an impurity (dopant) determining the color sense and efficiency. This just describes the basic structure of the OLED layer 280 include in the OLED panel. The present invention is not limited to the layer structure or material, etc., of the OLED layer 280.

The OLED layer 280 may further include an anode 291 and a cathode 297 with the above-described organic layer placed therebetween. When the TFT transistor becomes an on-state, a driving current is applied to the anode 291 and the electron holes are injected, and electrons are injected to the cathode 297. Then, the electron holes and electrons move to the organic material layer and emit the light.

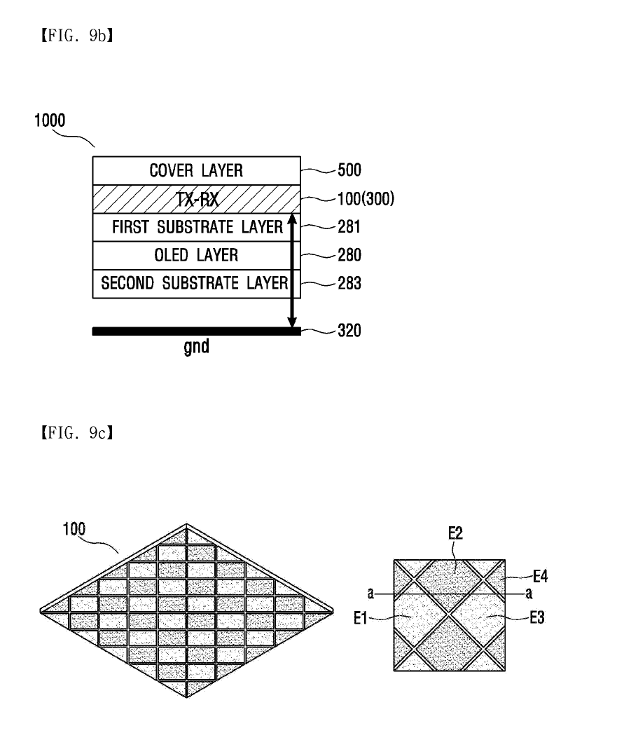

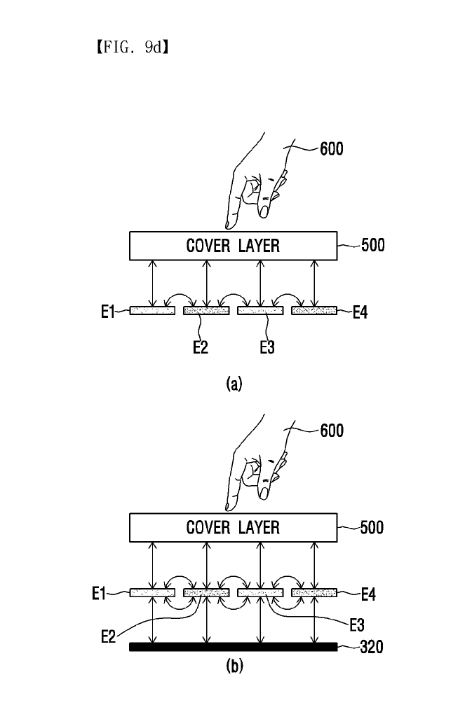

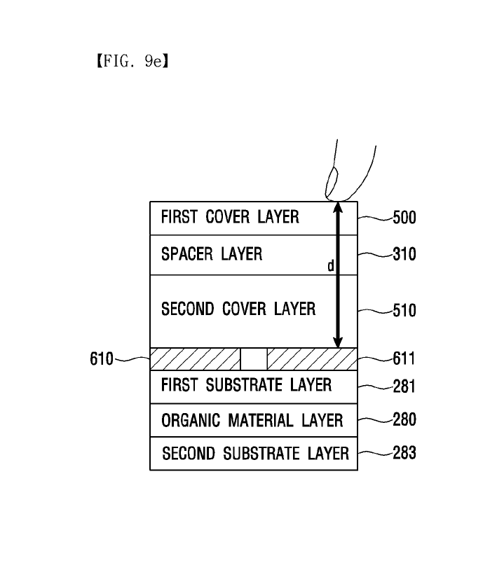

FIG. 9a shows a touch input device according to a second embodiment of the present invention. FIG. 9a shows that the touch sensor 100 is disposed between the first substrate layer 281 and the cover layer 500, which is applied when the reference potential is an object. In FIG. 9a, the touch sensor 100 may be formed on the first substrate layer 281, and the touch sensor 100 may be used as the pressure sensor 300. In the second embodiment of the present invention, the spacer layer 310 described with reference to FIG. 6a may be positioned between the pressure sensor 300 and the object. In FIG. 9a, the spacer layer 310 may be disposed in a space between the OLED panel and the cover layer 500.

Further, as described in the first embodiment, the second cover layer may be disposed under the cover layer 500, and the spacer layer 310 may be disposed between the cover layer 500 and the second cover layer.

In the second embodiment of the present invention as shown in FIG. 9a, as described with reference to FIG. 6a, the magnitude of the touch pressure can be detected through the mutual capacitance or the self-capacitance sensed by the pressure sensor 300, which changes according to the distance between the object and the pressure sensor 300.

Further, in the second embodiment of the present invention as shown in FIG. 9a, as described with reference to FIGS. 4c and 4d, the touch position can be detected through the self-capacitance or the mutual capacitance.

FIG. 9b shows another touch input device according to the second embodiment of the present invention. FIG. 9b shows the touch sensor 100, which is applied when the reference potential is spaced from the pressure sensor and when the reference potential is a reference potential layer located on, under or within the display panel 200A, is disposed between the first substrate layer 281 and the cover layer 500. In FIG. 9b, the touch sensor 100 may be formed on the first substrate layer 281, and the touch sensor 100 may be used as the pressure sensor 300. In the second embodiment of the present invention, the spacer layer 310 described with reference to FIG. 6h may be positioned between the pressure sensor 300 and the reference potential layer 320. In FIG. 9b, the spacer layer 310 may be disposed in a space between the OLED panel and the reference potential layer 320.

In the second embodiment of the present invention as shown in FIG. 9b, as described with reference to FIG. 6h, the magnitude of the touch pressure can be detected through the mutual capacitance or the self-capacitance sensed by the pressure sensor 300, which changes according to the distance between the reference potential layer 320 and the pressure sensor 300.

Further, in the second embodiment of the present invention as shown in FIG. 9b, as described with reference to FIGS. 4c and 4d, the touch position can be detected through the self-capacitance or the mutual capacitance.

FIG. 9c shows the arrangement of the touch sensors which can be included in the touch input device according to the second embodiment shown in FIGS. 9a and 9b. As shown in FIG. 4b, a plurality of electrodes may be arranged in the same layer. Here, the electrodes E1, E2, E3, and E4 which are obtained by cutting a portion of the touch sensor 100 along the line a-a as shown on the right side of FIG. 9c are shown in FIG. 9d.

FIG. 9d is a conceptual view for describing a principle of detecting the touch position and the touch pressure through the arrangement of the touch sensor shown in FIG. 9c. As shown in FIG. 9d, the touch position can be detected by sensing the self-capacitance from each of the electrodes E1, E2, E3, and E4 included in the touch sensor 100. Alternatively, the touch position can be detected by sensing the mutual electrostatic capacitance formed between the drive electrodes E1 and E3 and the receiving electrodes E2 and E4. This is the same as that described in FIGS. 4c and 4d.

Referring to FIG. 9d, one or more of the electrodes included in the touch sensor 100 are configured to detect the self-capacitance of the object 600 or the reference potential layer 320 and may be used to detect the touch pressure. Further, at least one pair of drive electrode TX and the receiving electrode RX among the electrodes included in the touch sensor 100 are configured to detect the mutual capacitance between the drive electrode TX and the receiving electrode RX, which changes according to the distance from the object 600 or the distance from the reference potential layer 320, and may be used to detect the touch pressure.

FIGS. 9a to 9d show that the touch sensor 100 is disposed in the same layer on the first substrate layer 281. However, in the touch sensor 100, the drive electrode TX and the receiving electrode RX may be formed in different layers. Alternatively, according to the embodiment, one of the drive electrode TX and the receiving electrode RX may be disposed on the first substrate layer 281 and the other may be disposed under the first substrate layer 281. Alternatively, according to the embodiment, the touch sensor 100 may be formed in the same layer or in different layers under the first substrate layer 281.

FIG. 9e is a cross sectional view of a touch input device according to another embodiment of the present invention. For example, the touch input device shown in FIG. 9e may include the first cover layer 500, the spacer layer 310 disposed under the first cover layer 500, the second cover layer 510 disposed under the spacer layer 310, the display module disposed under the second cover layer 510, and the third electrode 610 and the fourth electrode 611 which are disposed in the display module. The display module may include the first substrate layer 281 and the second substrate layer 283 disposed under the first substrate layer 281. The third electrode 610 and the fourth electrode 611 may be disposed on the first substrate layer 281.

As shown in FIG. 9e, the drive unit 120 according to the embodiment of the present invention may apply the touch position drive signal to the third electrode 610 and may apply the touch pressure drive signal to the fourth electrode 611. The sensing unit 110 may receive the touch position sensing signal and the touch pressure sensing signal from the fourth electrode 611.

As described in FIG. 1a, the touch position sensing signal including information on the mutual capacitance between the third electrode 610 and the fourth electrode 611, which changes according to the touch on the surface of the first cover layer 500, is received by the sensing unit 110 from the fourth electrode 611. Thus, the touch position can be detected.

When pressure is applied to the first cover layer 500 by the object, the spacer layer 310 is compressed, thereby reducing the distance between the object and the fourth electrode 611. Here, if the object serves as a ground (reference potential), the self-capacitance of the fourth electrode 611 changes according to the distance change between the object and the fourth electrode 611. Therefore, the touch pressure sensing signal including information on the self-capacitance of the fourth electrode 611, which changes according to the pressure applied to the first cover layer 500 is received by the sensing unit 110 from the fourth electrode 611. Thus, the touch pressure can be detected.

The controller 130 can control the sensing unit 110 such that the time for detecting the sensing signal from the fourth electrode 611 is time-divided and the touch position sensing signal is received from the fourth electrode 611 in the first time interval and the touch pressure sensing signal is received from the fourth electrode 611 in the second time interval different from the first time interval. In this case, the controller 130 can control the drive unit 120 such that the touch position drive signal is applied to the third electrode 610 in the first time interval and the touch pressure drive signal is applied to the fourth electrode 611 in the second time interval.

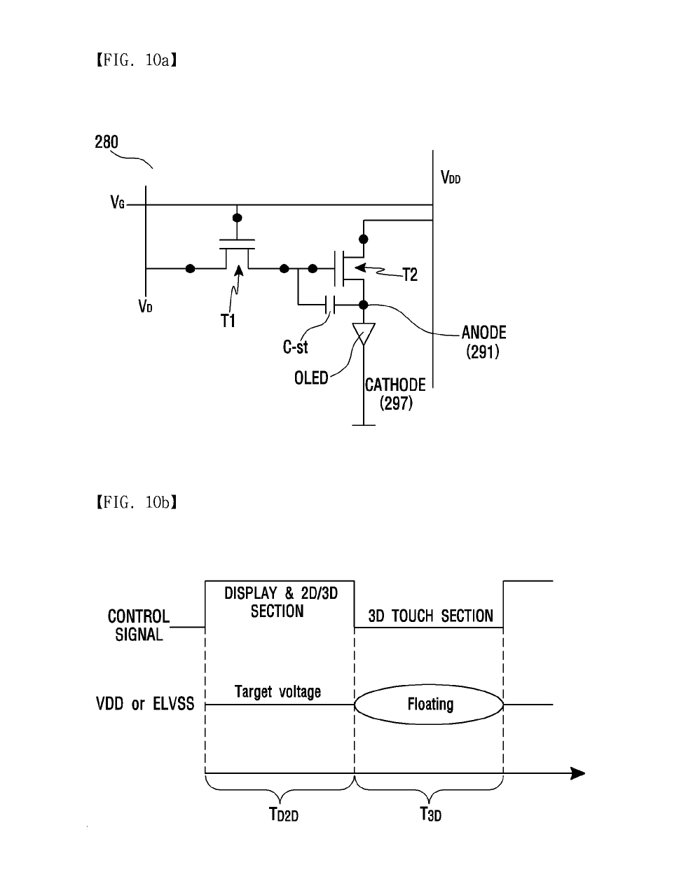

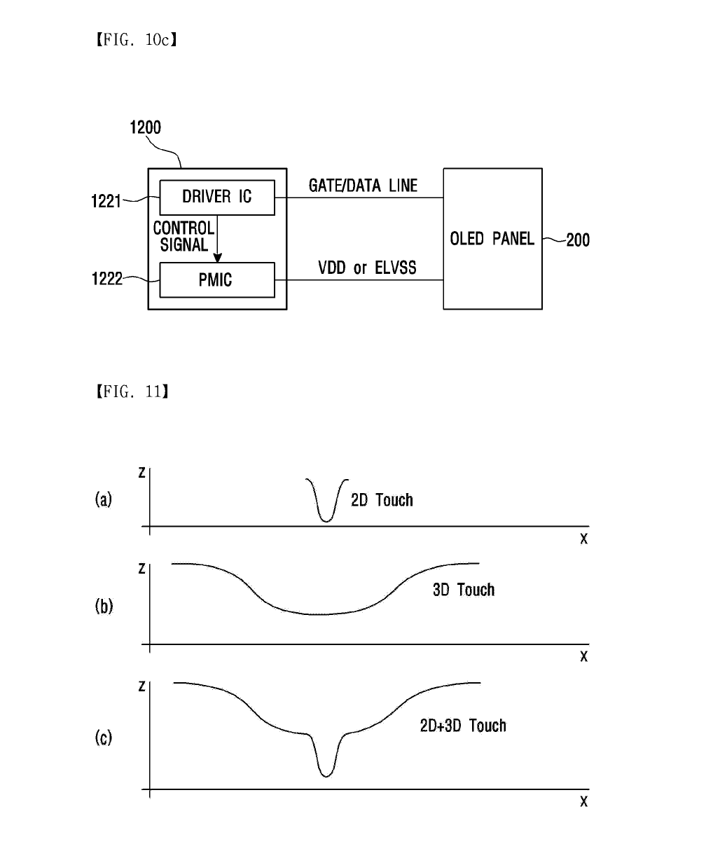

FIG. 10a is a display circuit structure diagram of the touch input device according to the second embodiment of the present invention. The display circuit may include an OLED device (OLED) having two terminals (a cathode terminal and an anode terminal), an n-type transistor such as a first transistor T1, and a p-type transistor such as a second transistor T2. The cathode terminal of the OLED device may be electrically connected to the cathode 297. The cathode 297 may be a signal line which is in common with respect to a plurality of pixel circuits within the touch screen, and may correspond to, for example, a common electrode. The anode terminal of the OLED device may be electrically connected to the anode 291. The OLED device may be connected to the cathode 297 and the anode 291 in such a way that electricity flows through the OLED device when the voltage at the anode is higher than the voltage at the cathode. That is, the OLED device becomes an on-state or becomes forward biased. The OLED device can emit light when it is in an on-state. When the voltage at the anode 291 is lower than the voltage at the cathode 297, no current flows through the OLED device substantially. That is, the OLED device becomes an off-state or becomes reverse biased. The OLED device may not emit substantially light when it is in an off-state.

The anode 291 may be electrically connected to the drain terminal of the second transistor T2. The gate and source terminals of the second transistor T2 may be capacitively connected through a capacitor C-st. One terminal of the capacitor C-st may be electrically connected to the gate terminal of the second transistor T2, and the other terminal of the capacitor C-st may be electrically connected to the source terminal of the second transistor T2. The source terminal of the second transistor T2 may be additionally electrically connected to the first power line. The gate terminal of the second transistor T2 may be additionally electrically connected to the drain terminal of the first transistor T1. The gate terminal of the first transistor T1 may be electrically connected to the gate line, and the source terminal of the first transistor T1 may be electrically connected to the data line.

During the display driving time interval of the touch input device 1000, the OLED device (OLED) can be forward biased, and current can flow through the OLED device, so that the OLED device can emit light. In order to allow the current to flow through the OLED device, a gate voltage VG which is high enough to turn on the first transistor T1 may be applied through the gate line. That is, the gate-to-source voltage of the first transistor T1 is sufficiently high, so that the gate voltage VG which is high enough to turn on the first transistor T1 can be applied. When the first transistor T1 is turned on, the first transistor T1 operates substantially as if the first transistor T1 is short-circuited, and thus, the data voltage VD applied through the data line may be substantially mirrored at the gate of the second transistor T2. Here, when the data voltage VD applied through the data line, that is, the voltage at the gate of the second transistor T2 is sufficiently low, the second transistor T2 may be turned on. In other words, the gate-source voltage of the second transistor T2 may be low enough to turn on the second transistor T2. When the second transistor T2 is turned on, the second transistor T2 may operate substantially as if the second transistor T2 is short-circuited, or alternatively, the second transistor T2 may function as a current source by an analog voltage applied to the gate of the second transistor T2. Accordingly, the first power voltage VDD on the first power line may be substantially mirrored on the anode 291 of the OLED device. Here, a holding capacitor C-st may be connected between the gate terminal and the source terminal of the second transistor T2 such that the analog voltage can be maintained. The second power voltage VSS may be applied to the cathode 297 through the first power line. In order that the OLED device is forward biased, the voltage at the anode 291, i.e., the first power voltage VDD may be higher than the voltage at the cathode 297 (i.e., the second power voltage VSS). When such a forward bias occurs, current flows through the OLED device and the OLED device emits light.

Although the foregoing has assumed that the second transistor T2 is a p-type TFT transistor, an n-type TFT transistor may be used according to the embodiment. In this case, the source terminal of the second transistor T2 may be electrically connected to the anode 291, and the drain terminal of the second transistor T2 may be electrically connected to the first power line.

FIG. 10b shows an electrical signal which is for detecting the touch position and touch pressure through the display panel of the touch input device according to the second embodiment of the present invention and is applied to the circuit structure shown in FIG. 10a.

In the second embodiment of the present invention, the touch input device 1000 can operate with the distinction of a display driving/touch position detection time interval and a touch pressure detection time interval. The distinction of the time interval can be made by a control signal. For example, when the control signal is 1 (high), the display driving/touch position detection time interval may be displayed, and when the control signal is 0 (low), the touch pressure detection time interval may be displayed.

In the display driving time interval, as with the LCD panel, a required data voltage VD is applied by applying the gate voltage VG in the on-state to the gate of the first transistor T1, so that the OLED can be controlled to perform necessary operations. Since the operation of the OLED is similar to that of the conventional OLED panel, detailed descriptions thereof will be omitted.

When the touch sensor 100 is disposed on the first substrate layer 281, it is possible to sense the touch position without being affected by the operation of the display. Accordingly, in this case, the touch position detection time interval may be equal to the display driving time interval.

However, in the display driving time interval, 0 V or a negative voltage as the second power voltage VSS may be applied to the cathode 297 through the second power line, and a positive voltage or 0 V as the first power voltage VDD may be applied to the anode 291 through the first power line. Therefore, in the touch pressure detection time interval, the first power line (ELVDD) and/or the second power line (ELVSS) need to be floating. Specifically, therefore, when the reference potential layer 320 is, as shown in FIG. 9a, spaced apart from the OLED panel, the first power line (ELVDD) and/or the second power line (ELVSS) need to be floating in the touch pressure detection time interval. In the second embodiment of the present invention, a target voltage required for driving the display may be, as described above, applied to each electrode node included in the OLED panel in the display driving/touch position detection. It is clear that the target voltage may vary depending on the embodiment. On the other hand, when the touch pressure is detected, at least one of the electrodes included in the OLED panel may be floating. For example, at least one of the gate line, the data line, the first power line (ELVDD), the second power line (ELVSS), and a ground line (GND line) must be floating.

Therefore, according to the second embodiment of the present invention, the display driving and the touch position detection may be performed simultaneously, and the touch pressure detection may be performed in a time interval separated from the display driving/touch position detection time interval. For example, as described with reference to FIG. 7b, it is possible that the display driving/touch position detection time interval and the touch pressure detection time interval are alternately arranged for each line.

However, it takes a long time to switch the power voltages VDD and VSS. Therefore, after the gate voltage VG is sequentially applied to all the gate lines in accordance with the embodiment and the scanning is completed, the touch pressure detection may be performed. That is, after the display driving and the touch position detection are continuously performed in the entire time interval in which one frame is refreshed, the touch pressure can be detected in the remaining time interval. Also, the display driving time interval and the touch position/pressure detection time interval may be variously arranged according to the embodiment.

In the above description, when the reference potential is an object, there is little or no interference in the touch position sensing by change of the distance from the object when the touch position is detected. In addition, in the case where the reference potential is spaced from the pressure sensor and the reference potential is the reference potential layer placed on, under or within the display panel 200A, since the display is operated when the touch position is detected, there is little or no interference in the touch position sensing by change of the distance from the reference potential layer 320. Accordingly, such a full touch position sensing measurement value can be used to correct the touch pressure value in the touch pressure detection. This is because the measurement value in the touch pressure detection reflects a change value by the touch of the object as well as the distance change between the object and the pressure sensor 300 or the distance change between the reference potential layer 320 and the pressure sensor 300.

More specifically, in the second embodiment of the present invention, when the reference potential is an object, interference by the distance change between the object and the touch sensor 100 in the touch position detection does not occur in the touch position detection. In addition, in the case where the reference potential is spaced from the pressure sensor and the reference potential is the reference potential layer placed on, under or within the display panel 200A, the OLED panel operates together in the touch position detection.

Therefore, since the reference potential layer 320 is invisible to the touch sensor 100, interference by the distance change between the reference potential layer 320 and the touch sensor 100 does not occur in the touch position detection. As a result, a sophisticated touch position measurement value can be obtained in the touch position detection. However, in the case where the touch object is a conductor such as a finger, when the touch position is detected, not only the distance change between the pressure sensor 300 and the object or the distance change between the reference potential layer 320 and the pressure sensor 300, but change in the measurement value occurs. Therefore, in order to obtain an accurate touch pressure magnitude, it is necessary to correct these influences of the interference by the object.

3D_{compensated}=f(3D_{sensing})−f(2D_{sensing)} Equation (1)

For example, as shown in Equation 1, the touch pressure magnitude can be detected by subtracting the touch position measurement value obtained when the touch position is detected from the touch pressure measurement value.

In the above, the case where the touch position is detected together with the display driving has been described. According to the embodiment, there may be a case where the touch position cannot be detected together with the display driving. For example, at least a portion of the touch sensor 100 is disposed within the OLED panel. In this case, the display driving and the touch position detection cannot be performed together. In this case, as described with reference to FIG. 7b, the touch input device 1000 can operate with the distinction of the display driving time interval and the touch position/pressure detection time interval. Here, according to the embodiment, the touch position and the pressure may be detected at the same time or may be detected in different time intervals.

FIG. 10c shows a control block of the display of the touch input device according to the second embodiment of the present invention. For example, as described with reference to FIG. 10b, a display controller 1200 of the OLED panel according to the second embodiment may include a driver IC 1221 and a power control IC 1222 (PMIC). Here, a control signal for controlling the mode may be provided from a host processor different from the driver IC 1221. The PMIC 1222 may be configured to apply the voltage VDD (ELVSS) for driving the display to the electrode node, etc., in the display driving/touch position detection time interval in accordance with the control signal, and may be configured to cause at least one of the electrode nodes to be floating in the touch pressure detection time interval in accordance with the control signal.

FIG. 11 shows data profiles in a spatial coordinate when a general touch occurs, when a pressure touch occurs, and when both the general touch and pressure touch occur. In FIGS. 11 and 12, the generic touch is referred to as a 2D touch which does not press/bend the cover layer 500 and/or the display module 200 of the touch input device 1000. The touch position of the touch input device 1000 can be detected through the 2D touch. The pressure touch is referred to as a 3D touch which causes the pressing/bending of the cover layer 500 and/or the display module 200 of the touch input device 1000.

Referring to (a) and (b) of FIG. 11, the 2D touch has a relatively narrower and more pointed output data profile than that of the 3D touch in the spatial coordinate domain, and the 3D touch has a relatively wider and softer output data profile. When the data on the 2D touch and the 3D touch are mixed and enter the sensing unit 110, etc., the data profile as shown in (c) of FIG. 11c can be obtained. Here, the data may be information on capacitance and/or capacitance change amount.

FIG. 12 shows a method of separating the general touch and the pressure touch when the general touch and the pressure touch are mixed. When the data obtained by mixing the 2D touch data and the 3D touch data is converted from the spatial coordinate domain to the frequency domain and then is, as shown in (a) of FIG. 12, passed through a low pass filter, the 3D touch data can be obtained. When the data obtained by mixing the 2D touch data and the 3D touch data is converted from the spatial coordinate domain to the frequency domain and then is, as shown in (b) of FIG. 12, passed through a high pass filter, the 2D touch data can be obtained.

The process of separating the 2D touch data and the 3D touch data, which has been described with reference to FIG. 12, may be performed in the sensing unit 110, the touch/pressure controller 1100, the processor 1500, and the like

FIGS. 11 and 12 show that the data profile changes in the same direction when the 2D touch and the 3D touch occur. That is, FIGS. 11 and 12 show that all data profiles change concavely when the 2D touch and the 3D touch occur. However, according to the embodiment, the data profiles may change in different directions when the 2D touch and the 3D touch occur. For example, while the data profile may change concavely when the 3D touch occurs, the data profile may change convexly when the 2D touch occurs. Alternatively, while the data profile may change convexly when the 3D touch occurs, the data profile may change concavely when the 2D touch occurs. According to the embodiment, all data profiles may change convexly in the same direction when the 2D touch and the 3D touch occur. The 2D touch data and the 3D touch data can be separated according to the above-described separation method regardless of the direction of change of the data profile.

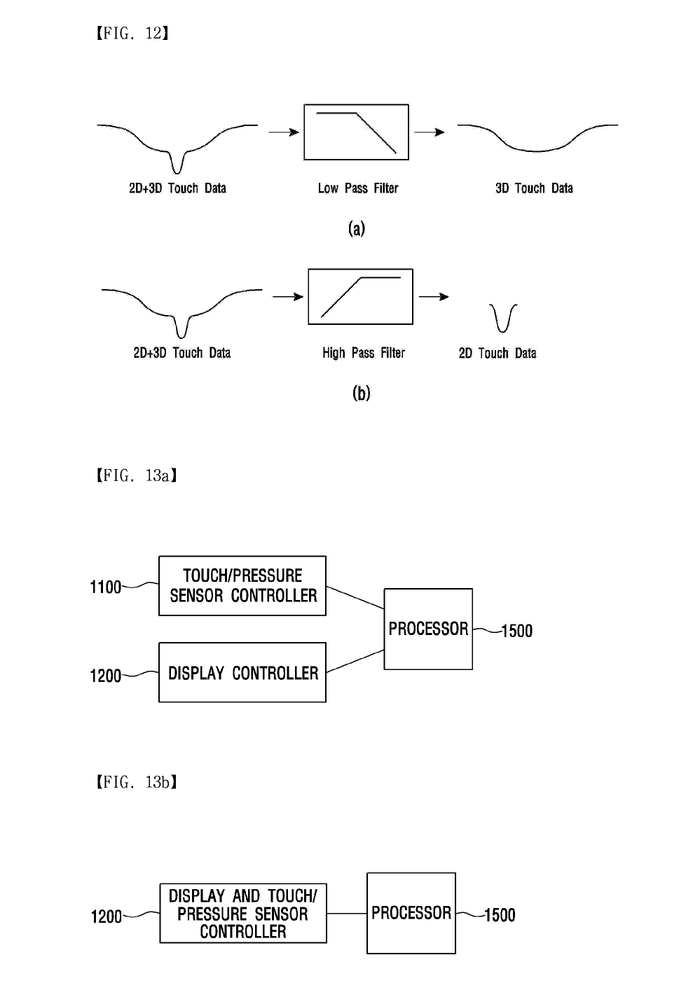

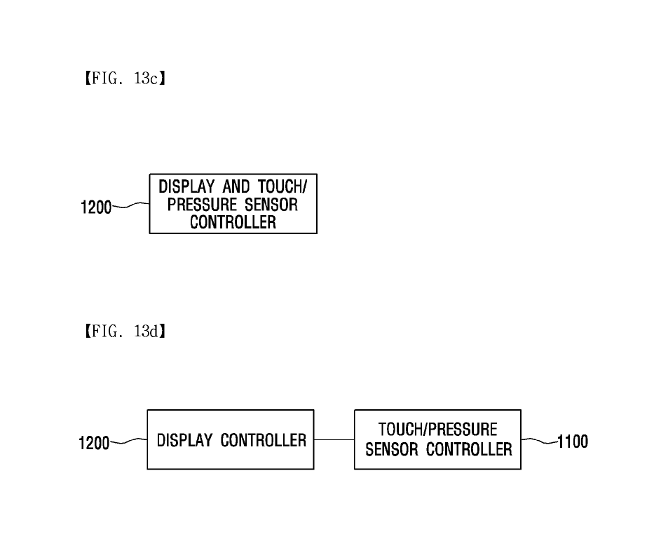

FIGS. 13a to 13d show various configurations of the control block included in the touch input device according to the embodiment of the present invention.

As shown in FIG. 13a, in the embodiment of the present invention, the touch sensor controller 1100 may be integrated with the pressure sensor controller 1300, and the display controller 1200 may be separately formed. Here, the host processor 1500 may be separately provided to transmit the control signal to the touch/pressure sensor controller 1100 and the display controller 1200, and to collect and process information from the controllers 1100 and 1200.

As shown in FIG. 13b, in the embodiment of the present invention, the touch sensor controller 1100 and the pressure sensor controller 1300 may be integrated with the display controller 1200, so that one controller is configured. Here, the host processor 1500 may be separately provided to transmit the control signal to the display and touch/pressure sensor controller 1200, and to collect and process information from the controller 1200.

As shown in FIG. 13c, in the embodiment of the present invention, the touch sensor controller 1100 and the pressure sensor controller 1300 may be integrated with the display controller 1200, so that one controller is configured. Here, the host processor 1500 may not be separately provided, and the display and touch/pressure sensor controller 1200 as the host processor may directly generate the control signal and collect and process the obtained information.

As shown in FIG. 13d, in the embodiment of the present invention, the touch sensor controller 1100 may be integrated with the pressure sensor controller 1300, and the display controller 1200 may be separately formed. Here, the host processor 1500 is not separately provided, and the display controller 1200 or the touch/pressure sensor controller 1100 as the host processor may generate the control signal and collect and process information obtained from the counterpart controller.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

### REFERENCE NUMERALS

1000: touch input device 100: touch sensor

120: drive unit 110: sensing unit

130: controller 200: display module

300: pressure sensor 1100: touch sensor controller

1200: display controller

1300: pressure sensor controller

1500: processor

1. A touch input device comprising:
a first cover layer;
a spacer layer;
a display panel which comprises a first substrate layer and a second substrate layer disposed under the first substrate layer;
a first electrode and a second electrode which are disposed between the first substrate layer and the second substrate layer; and
a third electrode and a fourth electrode which are disposed on the display panel,
wherein at least one of the first electrode and the second electrode is used to drive the display panel,
wherein a touch position is detected based on a capacitance which changes as an object approaches a touch sensor comprising at least one of the first electrode, the second electrode, the third electrode, and the fourth electrode and which is detected from the touch sensor,
wherein a touch pressure is detected based on a capacitance which is changed by change of a distance between the object and a pressure sensor comprising at least one of the first electrode, the second electrode, the third electrode, and the fourth electrode and which is detected from the pressure sensor,
and wherein the spacer layer is disposed between the first cover layer and the pressure sensor.

2. The touch input device of claim 1,
wherein the touch sensor comprises the third electrode and the fourth electrode,
and wherein the touch position is detected based on a mutual capacitance between the third electrode and the fourth electrode.

3. The touch input device of claim 1,
wherein the touch sensor comprises the third electrode,
and wherein the touch position is detected based on a self-capacitance of the third electrode.

4. The touch input device of claim 1,
wherein the touch sensor comprises the first electrode and the third electrode,
and wherein the touch position is detected based on a mutual capacitance between the first electrode and the third electrode.

5. The touch input device of claim 4, wherein the first electrode is a common electrode.

6. A touch input device comprising:
a first cover layer;
a spacer layer;
a display panel which comprises a first substrate layer and a second substrate layer disposed under the first substrate layer;
a first electrode and a second electrode which are disposed between the first substrate layer and the second substrate layer; and
a third electrode and a fourth electrode which are formed on a top surface of the first substrate layer,
wherein at least one of the first electrode and the second electrode is used to drive the display panel,
wherein a touch position is detected based on a capacitance which changes as an object approaches a touch sensor comprising at least one of the first electrode, the second electrode, the third electrode, and the fourth electrode and which is detected from the touch sensor,
wherein a touch pressure is detected based on a capacitance which is changed by change of a distance between the object and a pressure sensor comprising at least one of the first electrode, the second electrode, the third electrode, and the fourth electrode and which is detected from the pressure sensor,
and wherein the spacer layer is disposed between the first cover layer and the pressure sensor.

7. The touch input device of claim 6,
wherein the touch sensor comprises the third electrode and the fourth electrode,
and wherein the touch position is detected based on a mutual capacitance between the third electrode and the fourth electrode.

8. The touch input device of claim 6,
wherein the touch sensor comprises the third electrode,
and wherein the touch position is detected based on a self-capacitance of the third electrode.

9. The touch input device of claim 6,
wherein the touch sensor comprises the first electrode and the third electrode,
and wherein the touch position is detected based on a mutual capacitance between the first electrode and the third electrode.

10. The touch input device of claim 9, wherein the first electrode is a common electrode.

11. A touch input device comprising:
a first cover layer;
a spacer layer;
a display panel which comprises a first substrate layer and a second substrate layer disposed under the first substrate layer; and
a first electrode and a second electrode which are disposed between the first substrate layer and the second substrate layer,
wherein at least one of the first electrode and the second electrode is used to drive the display panel,
wherein a touch position is detected based on a capacitance which changes as an object approaches a touch sensor comprising at least one of the first electrode and the second electrode and which is detected from the touch sensor,
wherein a touch pressure is detected based on a capacitance which is changed by change of a distance between the object and a pressure sensor comprising at least one of the first electrode and the second electrode and which is detected from the pressure sensor,
and wherein the spacer layer is disposed between the first cover layer and the pressure sensor.

12. The touch input device of claim 11,
wherein the touch sensor comprises the first electrode and the second electrode,
and wherein the touch position is detected based on a mutual capacitance between the first electrode and the second electrode.

13. The touch input device of claim 12, wherein at least one of the first electrode and the second electrode is a common electrode.

14. The touch input device of claim 11,
wherein the touch sensor comprises the first electrode,
and wherein the touch position is detected based on a self-capacitance of the first electrode.

15. The touch input device of claim 14, wherein the first electrode is a common electrode.

16. The touch input device of claim 1,
wherein the pressure sensor comprises the third electrode and the fourth electrode,
and wherein the touch pressure is detected based on the mutual capacitance between the third electrode and the fourth electrode.

17. The touch input device of claim 1,
wherein the pressure sensor comprises the third electrode,
and wherein the touch pressure is detected based on the self-capacitance of the third electrode.

18. The touch input device of claim 1,
wherein the pressure sensor comprises the first electrode and the third electrode,
and wherein the touch pressure is detected based on the mutual capacitance between the first electrode and the third electrode.

19. The touch input device of claim 18, wherein the first electrode is a common electrode.

20. The touch input device of claim 1,
wherein the pressure sensor comprises the first electrode and the second electrode,
and wherein the touch pressure is detected based on the mutual capacitance between the first electrode and the second electrode.

21-57. (canceled)
